(19) United States
(12) Patent Application Publication
(10) Pub. No.: US 2022/0172606 A1
(43) Pub. Date: Jun. 2, 2022

(54) Systems and Methods for Extracting Data From Autonomous Vehicles

(71) Applicant: Ridecell, Inc., San Francisco, CA (US)

(72) Inventors: Samyak Pandya, San Francisco, CA (US); Jit Ray Chowdhury, San Jose, CA (US); Srinivas Aellala Reddy, Sunnyvale, CA (US); Nalin Gupta, Sunnyvale, CA (US); Arpan Chakraborty, San Jose, CA (US); Gaurav Singh, San Jose, CA (US)

(21) Appl. No.: 17/539,915

(22) Filed: Dec. 1, 2021

Related U.S. Application Data
(60) Provisional application No. 63/119,870, filed on Dec. 1, 2020.

(51) Int. Cl. G08G 1/01; G08G 1/04; G06F 16/28; G06V 20/58

(52) U.S. Cl. CPC G08G 1/0112; G08G 1/0133; G08G 1/0129; G01S 19/42; G06F 16/285; G06V 20/58; G08G 1/04

(57) ABSTRACT

An example method for extracting traffic scenarios from vehicle sensor data is disclosed. The example method includes acquiring vehicle data generated by one or more sensors coupled to a vehicle. The vehicle data is at least partially indicative of the surroundings of the vehicle during a particular time frame. The vehicle data is analyzed to identify objects in the surroundings of the vehicle and to determine the motion of the vehicle relative to the surroundings during the particular time frame. A plurality of events are defined, each indicative of a relationship between the vehicle and the objects. A scenario is defined as a particular combination of the events. Portions of the vehicle data in which the combination of elements occurs during a time interval are identified, and at least some of the identified data is extracted to a predefined data structure to create an extracted scenario.

### RELATED CASES

The present invention claims priority to U.S. Provisional Patent Application No. 63/119,870, filed on Dec. 1, 2020 by at least one common inventor and entitled “Systems and Methods for Extracting Data from Autonomous Vehicles”, which is incorporated by reference herein in its entirety.

### BACKGROUND OF THE INVENTION

### Field of the Invention

This invention relates generally to autonomous vehicles, and more particularly to extracting and processing data from autonomous vehicles.

### Description of the Background Art

Autonomous vehicles, i.e. vehicles that do not require a human driver, are being rapidly developed. Autonomous vehicles include systems (e.g. sensors) for detecting other vehicles, road markings, road signs, pedestrians, and other relevant objects in their surroundings. Data from these sensors is input into an onboard computer system capable of directing the vehicle's movement based on the data received from the sensors. The onboard computer system provides output to the vehicle's controls in order to cause the vehicle to accelerate, decelerate, brake, steer, reverse, etc. The onboard computer must determine the most appropriate maneuvers based on the input from the sensors in order to, for example, avoid collisions, obey traffic laws, etc.

Autonomous vehicles are additionally equipped with location determining systems (e.g. global positioning systems (GPS) receivers) and wireless communications systems (e.g. cellular modems). These systems are utilized to determine the location of the vehicle, communicate the location of the vehicle (if necessary), and receive route instructions based at least in part on the location of the vehicle. The route instructions are considered (in addition to input from the sensors) by the onboard computer in order to determine the most appropriate maneuvers for traveling to a desired location.

The sensors deployed by an autonomous vehicle generate data during operation. This data includes information about the operation of the autonomous vehicle, such as traffic conditions, particular maneuvers made by the vehicle, etc. The data can be captured by communications systems in communication with the vehicle for various uses. However, a large amount of data (e.g., terabytes per day) is produced and much of it is not useful. Therefore, the cost associated with storing and analyzing the data is significant.

### SUMMARY

The present invention overcomes the problems associated with the prior art by providing systems and methods for extracting data from autonomous vehicles and processing the data to extract useful portions of the data. The invention facilitates identifying particular driving scenarios from the extracted data and utilizing the scenarios for various productive purposes. For example, the present invention may be utilized to determine that an autonomous vehicle drove for several miles on an otherwise empty road, in which case the resultant data is not likely important. However, the present invention may also be utilized to determine that the autonomous vehicle was forced to decelerate when another vehicle entered the roadway ahead of it, in which case the resultant data likely is important. Data that is deemed important can then be stored and utilized for actuarial purposes, machine learning research, testing and training simulation, etc.

Method for extracting traffic scenarios from vehicle sensor data are disclosed An example method includes acquiring vehicle data, analyzing the vehicle data, identifying a portion of the vehicle data, and extracting a traffic scenario. The acquired vehicle data can be generated by one or more sensors coupled to a vehicle and can be at least partially indicative of the surroundings of the vehicle during a particular time frame. The vehicle data can be analyzed to identify objects in the surroundings of the vehicle during the particular time frame, and can also be analyzed to determine the motion of the vehicle relative to the surroundings during the particular time frame. The identified portion of the vehicle data can correspond to an interval of the particular time frame, and the identified portion of the vehicle data can be identified based at least in part on a relationship between the identified objects in the surroundings of the vehicle and the motion of the vehicle relative to the surroundings during the interval of the particular time frame. The extracted traffic scenario can correspond to the interval of the particular time frame and can be extracted based at least in part on the objects in the surroundings and the motion of the vehicle relative to the surroundings.

An example method additionally includes classifying the traffic scenario based at least in part on the objects in the surroundings and the motion of the vehicle relative to the surroundings. By way of non-limiting example, the identified objects can include at least a second vehicle, and the step of classifying the traffic scenario can include classifying the traffic scenario based at least in part on the relative motions between the vehicle and the second vehicle. As another non-limiting example, the identified objects can include at least a section of roadway infrastructure, and the step of classifying the traffic scenario can include classifying the traffic scenario based at least in part on the motion of the vehicle relative to the section of roadway infrastructure.

In an example method, the one or more sensors can include a global positioning system (GPS) receiver. In addition, the vehicle data can include GPS data, and the section of roadway infrastructure can be identified based at least in part on the GPS data. Optionally, the section of roadway infrastructure can be identified based at least in part on map data.

In an example method, the step of classifying the traffic scenario can include storing an entry, indicative of the portion of the vehicle data, in a searchable database. The step of storing an entry indicative of the portion of the vehicle data in a searchable database can include associating the portion of the vehicle data with one or more metadata tags, and the metadata tags can be descriptive of the classified scenario and be searchable.

In an example method, the one or more sensors can include a camera. The vehicle data can include video data, and the step of analyzing the vehicle data to identify objects in the surroundings of the vehicle during the particular time frame can include analyzing the video data. The step of analyzing the vehicle data to determine the motion of the vehicle relative to the surroundings during the particular time frame can also include analyzing the video data. Optionally, the one or more sensors can include only a camera, and the vehicle data can include only video data.

An example method can additionally include comparing the extracted traffic scenario to a baseline traffic scenario, according to an actuarial model, to generate a scenario comparison. The scenario comparison can then be utilized to inform an insurance risk calculation corresponding to the vehicle.

Another example method can additionally include storing the vehicle data corresponding to the particular time frame in a first storage device and storing the portion of the vehicle data corresponding to the interval of the particular time frame in a second storage device. The first storage device and the second storage device can have different storage attributes. For example, the second storage device can be more accessible than the first storage device.

Example systems for extracting traffic scenarios from vehicle sensor data are also disclosed. An example system includes at least one hardware processor, a network adapter, and memory. The at least one hardware processor can be electronically coupled to execute code, and the code can include a set of native instructions configured to cause a corresponding set of operations upon execution by the at least one hardware processor. The network adapter can be configured to establish a connection with a data network. The memory can store data and the code. The code can include a data interface and a scenario extraction service. The data interface can include a first subset of the set of native instructions configured to acquire vehicle data generated by one or more sensors coupled to a vehicle. The vehicle data can be at least partially indicative of the surroundings of the vehicle during a particular time frame. The scenario extraction service can include second, third, fourth, and fifth subsets of the set of native instructions. The second subset of the set of native instructions can be configured to analyze the vehicle data to identify objects in the surroundings of the vehicle during a particular time frame. The third subset of the set of native instructions can be configured to analyze the vehicle data to determine the motion of the vehicle relative to the surroundings during the particular time frame. The fourth subset of the set of native instructions can be configured to identify a portion of the vehicle data corresponding to an interval of the particular time frame. The portion of the vehicle data being identified can be identified based at least in part on a relationship between the identified objects in the surroundings of the vehicle and the motion of the vehicle relative to the surroundings during the interval of the particular time frame. The fifth subset of the set of native instructions can be configured to extract a traffic scenario corresponding to the interval of the particular time frame based at least in part on the objects in the surroundings and the motion of the vehicle relative to the surroundings.

In an example system, the scenario extraction service can include a sixth subset of the set of native instructions configured to classify the traffic scenario based at least in part on the objects in the surroundings and the motion of the vehicle relative to the surroundings. By way of non-limiting example, the identified objects can include at least a second vehicle, and the sixth subset of the set of native instructions can be configured to classify the traffic scenario based at least in part on the relative motions between the vehicle and the second vehicle. As another non-limiting example, the identified objects can include at least a section of roadway infrastructure, and the sixth subset of the set of native instructions can be configured to classify the traffic scenario based at least in part on the motion of the vehicle. As yet another non-limiting example, the at least one sensor can include a global positioning system (GPS) receiver, the vehicle data can include GPS data, and the second subset of the set of native instructions can be configured to identify the section of roadway infrastructure based at least in part on the GPS data. Optionally, the second subset of the set of native instructions can be configured to identify the section of roadway infrastructure based at least in part on map data.

In an example system, the sixth subset of the set of native instructions can be configured to store an entry, indicative of the portion of the vehicle data, in a searchable database. The sixth subset of the set of native instructions can be additionally configured to associate the portion of the vehicle data with one or more metadata tags, which can be descriptive of the classified scenario and searchable.

In an example system, the one or more sensors can include a camera, and the vehicle data can include video data. The second subset of the set of native instructions can be configured to analyze the video data to identify the objects in the surroundings of the vehicle during the particular time frame. The third subset of the set of native instructions can be configured to analyze the video data to determine the motion of the vehicle relative to the surroundings during the particular time frame. Optionally, the one or more sensors can include only a camera, and the vehicle data can include only video data.

An example system can additionally include an actuarial modeling service. The actuarial modeling service can include a sixth and seventh subset of the set of native instructions. The sixth subset of the set of native instructions can be configured to compare the extracted traffic scenario to a baseline traffic scenario, according to an actuarial model, to generate a scenario comparison. The seventh subset of the set of native instructions can be configured to utilize the scenario comparison to inform an insurance risk calculation corresponding to the vehicle.

Another example system can include a storage interface including a sixth subset of the set of native instructions. The sixth subset of the set of native instructions can be configured to store the vehicle data corresponding to the particular time frame in a first storage device, and store the portion of the vehicle data corresponding to the interval of the particular time frame in a second storage device. The first storage device and the second storage device can have different storage attributes. For example, the second storage device can be more accessible than the first storage device.

Another example method for extracting traffic scenarios from vehicle sensor data includes acquiring vehicle data, analyzing the vehicle data, defining a plurality of events, defining a scenario, identifying a portion of the vehicle data, and extracting at least some of the data. The vehicle data can be generated by one or more sensors coupled to a vehicle, and the vehicle data can be at least partially indicative of the surroundings of the vehicle during a particular time frame. The vehicle data can be analyzed to identify objects in the surroundings of the vehicle during the particular time frame. The vehicle data can also be analyzed to determine the motion of the vehicle relative to the surroundings during the particular time frame. Each defined event can be indicative of a relationship between the vehicle and the objects. The scenario can be defined as a particular combination of the events. Identifying the portion of the vehicle data can include identifying a portion of the vehicle data wherein the combination of the elements occurs during an interval of the particular time frame. The interval of the particular time frame can have a predefined maximum duration (e.g., to make it more probable that the combined events are part of a single physical occurrence). At least some of the data of the corresponding to the interval of the particular time frame can then be extracted to a predefined data structure corresponding to the scenario, to create an extracted scenario. As a result of the predefined data structure, the extracted scenario can be used in a simulator. Optionally, the example method additionally includes actually using the extracted scenario in a simulator.

In an example method, at least one of the events can be defined as a particular relative movement between the vehicle and a second vehicle. As another non-limiting example, at least one of the events can be defined as the presence of a particular object in the vicinity of the vehicle. As yet another non-limiting example, at least one of the events is defined as a location of the vehicle within a particular section of roadway infrastructure.

In an example method, the particular combination of events can include a first event and a second event. The first event can be defined as a particular relative movement between the vehicle and a second vehicle. The second event can be defined as the presence of a particular object in the vicinity of the vehicle. The particular combination of events can additionally include a third event defined as a location of the vehicle within a particular section of roadway infrastructure.

### BRIEF DESCRIPTION OF THE DRAWINGS

The patent or application file contains at least one drawing executed in color. Copies of this patent or patent application publication with color drawings will be provided by the Office upon request and payment of the necessary fee.

The present invention is described with reference to the following drawings, wherein like reference numbers denote substantially similar elements:

FIG. 1 is a diagram showing a fleet of vehicles communicating with a remote data computing system;

FIG. 2 is a block diagram showing a server of FIG. 1 in greater detail;

FIG. 3 is a data flow diagram showing data flow from autonomous vehicles to automotive software developers;

FIG. 4A is a data flow diagram illustrating a method for utilizing driving data for insurance risk scoring and displaying scenarios via a graphical user interface (GUI);

FIG. 4B is a data flow diagram illustrating a method for extracting scenarios from the driving data of FIG. 4A;

FIG. 5A is a data flow diagram showing example categories of traffic events stored in a database of real-world events;

FIG. 5B is a diagram illustrating several of the example traffic events of FIG. 5A, in an example traffic scenario;

FIG. 6 is a table showing example traffic events in a database for search, query, and retrieval;

FIG. 7 is a table illustrating example metadata for searching and filtering through extracted traffic events;

FIG. 8 is an example collection of photographs illustrating various scenarios that occur during operation of an autonomous vehicle;

FIG. 9 is an example table showing explanations of how components of a traffic scenario are captured in and/or extracted from the data;

FIG. 10 is a data flow diagram illustrating an example method for capturing events from pre-processed vehicle driving data;

FIG. 11 is a diagram showing the relative positions and headings of two vehicles on a roadway;

FIG. 12 is an example collection of photographs illustrating visual processing utilized by the Ego-Object Annotation module of FIG. 10;

FIG. 13 is a table illustrating the pose code configuration of FIG. 10;

FIG. 14 is a diagram showing example traffic scenarios;

FIG. 15 is a data flow diagram illustrating an example method for extracting traffic scenarios from a collection of traffic events;

FIG. 16A is an example query graph of FIG. 15;

FIG. 16B is an example drive graph of FIG. 15;

FIG. 16C is an example annotated version of the drive graph of FIG. 16B illustrating the graph matching of FIG. 15;

FIG. 16D is an example fragment of a matched drive graph;

FIG. 17 is an example heat map derived by parameter extraction showing traffic scenarios against different map areas;

FIG. 18A is a diagram illustrating example extracted parameters of FIG. 15;

FIG. 18B is an example data plot showing extracted velocity parameter data;

FIG. 19 is a flow chart illustrating an example method for recreating a real-world traffic scenario in a simulation; and

FIG. 20 is a flow chart illustrating an example method for extracting traffic scenarios from vehicle data.

### DETAILED DESCRIPTION

The present invention overcomes the problems associated with the prior art, by providing systems and methods for acquiring sensor data from autonomous vehicles and filtering the data to identify data of particular interest (e.g., data indicative of traffic events and/or scenarios). In the following description, numerous specific details are set forth (e.g., particular system infrastructure, particular data types, etc.) in order to provide a thorough understanding of the invention. Those skilled in the art will recognize, however, that the invention may be practiced apart from these specific details. In other instances, details of well-known autonomous driving practices (e.g., route planning, maneuvering, routine optimization, etc.) and components (autonomous vehicle sensors, control systems, etc.) have been omitted, so as not to unnecessarily obscure the present invention.

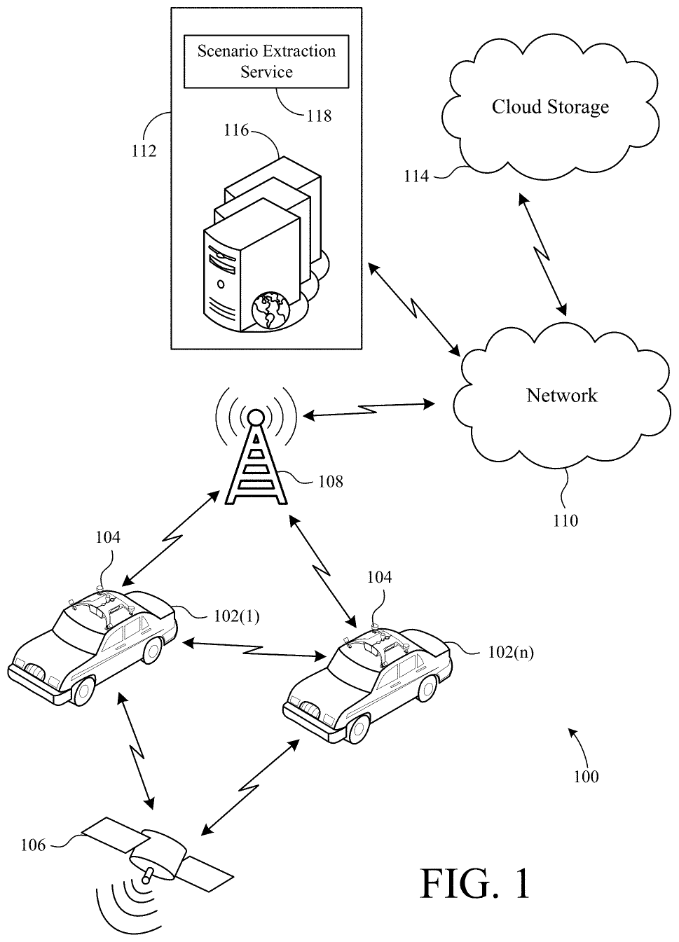

FIG. 1 shows an autonomous vehicle infrastructure 100, including a fleet of autonomous vehicles 102(1-n). In the example embodiment, the fleet of autonomous vehicles includes legacy vehicles (i.e., vehicles originally intended to be piloted by a human) that are outfitted with a detachable sensor unit 104 that includes a plurality of sensors (e.g., cameras, radar, lidar, etc.). The sensors enable the legacy vehicle to be piloted in the same way as a contemporary autonomous vehicle, by generating and providing data indicative of the surroundings of the vehicle. More information regarding detachable sensor units can be found in U.S. patent application Ser. No. 16/830,755, filed on Mar. 26, 2020 by Anderson et al., which is incorporated herein by reference in its entirety. In alternate embodiments, vehicles 102(1-n) can include any vehicles outfitted with some kind of sensor (e.g., a dashcam) that is capable of capturing data indicative of the surroundings of the vehicle, whether or not the vehicles are capable of being piloted autonomously.

For the ease of operation, vehicles 102 should be able to identify their own locations. To that end, vehicles 102 receive signals from global positioning system (GPS) satellites 106, which provide vehicles 102 with timing signals that can be compared to determine the locations of vehicles 102. The location data is utilized, along with appropriate map data, by vehicles 102 to determine intended routes and to navigate along the routes. In addition, recorded GPS data can be utilized along with corresponding map data in order to identify roadway infrastructure, such as roads, highways, intersections, etc.

Vehicles 102 must also communicate with riders, administrators, technicians, etc. for positioning, monitoring, and/or maintenance purposes. To that end, vehicles 102 also communicate with a wireless communications tower 108 via, for example, a wireless cell modem (not shown) installed in vehicles 102 or sensor units 104. Vehicles 102 may communicate (via wireless communications tower 108) sensor data, location data, diagnostic data, etc. to relevant entities interconnected via a network 110 (e.g., the Internet). The relevant entities include, for example, a data center 112 and a cloud storage provider 114. Communications between vehicles 102 (and/or sensor units 104) and data center 112 may assist piloting, redirecting, and/or monitoring of autonomous vehicles 102. Cloud storage provider 114 provides storage for data generated by sensor units 104 and transmitted via network 110, the data being potentially useful.

Although vehicles 102 are described as legacy vehicles retrofitted with autonomous piloting technology, it should be understood that vehicles 102 can be originally manufactured autonomous vehicles, vehicles equipped with advanced driver-assistance systems (ADAS), vehicles outfitted with dashcams or other systems/sensors, and so on. The data received from vehicles 102 can be any data collected by vehicles 102 and utilized for any purpose (e.g., park assist, lane assist, auto start/stop, etc.).

Data center 112 includes one or more servers 116 utilized for communicating with vehicles 102. Servers 116 also include at least one scenario extraction service 118. Scenario extraction service 118 extracts data related to traffic events and/or scenarios from the large amount of sensor data received from vehicles 102 and/or sensor units 104. This extracted data can be used for a number of purposes including, but not limited to, actuarial calculation, machine learning research, autonomous vehicle simulations, etc. More detail about the extraction process is provided below.

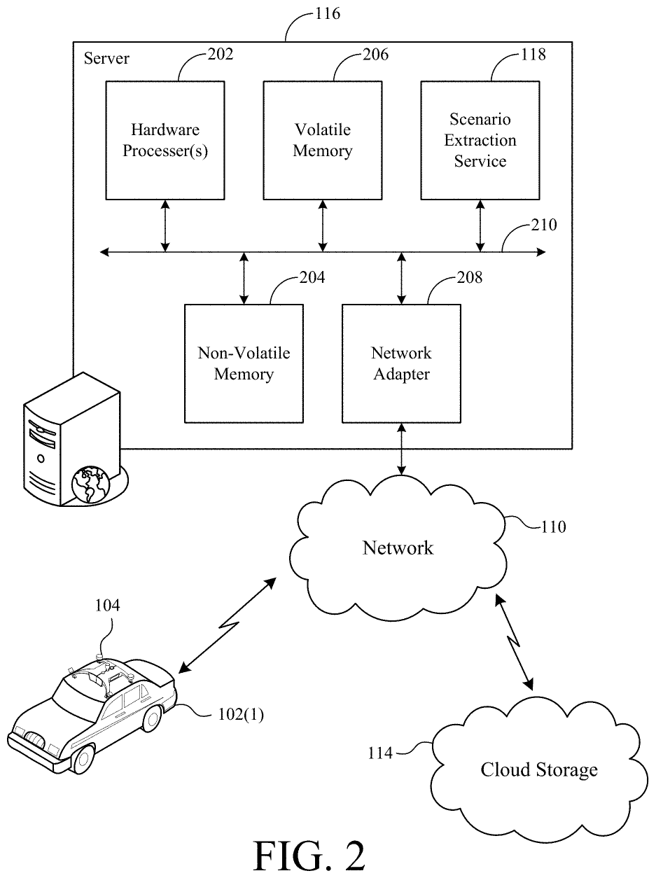

FIG. 2 is a block diagram showing an example one of servers 116 in greater detail. Server 116 includes at least one hardware processor 202, non-volatile memory 204, working memory 206, a network adapter 208, and scenario extraction service 118, all interconnected and communicating via a system bus 210. Hardware processor 202 imparts functionality to server 116 by executing code stored in any or all of non-volatile memory 204, working memory 206, and scenario extraction service 118. Hardware processor 202 is electrically coupled to execute a set of native instructions configured to cause hardware processor 202 to perform a corresponding set of operations when executed. In the example embodiment, the native instructions are embodied in machine code that can be read directly by hardware processor 202. Software and/or firmware utilized by server 116 include(s) various subsets of the native instructions configured to perform specific tasks related to the functionality of server 116. Developers of the software and firmware write code in a human-readable format, which is translated into a machine-readable format (e.g., machine code) by a suitable compiler.

Non-volatile memory 204 stores long term data and code including, but not limited to, software, files, databases, applications, etc. Non-volatile memory 204 can include several different storage devices and types, including, but not limited to, hard disk drives, solid state drives, read-only memory (ROM), etc. distributed across data center 112. Hardware processor 202 transfers code from non-volatile memory 204 into working memory 206 and executes the code to impart functionality to various components of server 116. For example, working memory 206 stores code, such as software modules, that when executed provides the described functionality of server 116. Working memory 206 can include several different storage devices and types, including, but not limited to, random-access memory (RAM), non-volatile RAM, flash memory, etc. Network adapter 208 provides server 116 with access (either directly or via a local network) to network 110. Network adapter 208 allows server 116 to communicate with vehicles 102, sensor units 104, and cloud storage 114, among others.

Scenario extraction service 118 includes software and/or firmware configured for analyzing vehicle data and isolating sections of the data corresponding to traffic events and/or scenarios of interest. Service 118 utilizes processing power, data, storage, etc. from hardware processor 202, non-volatile memory 204, working memory 206, and network adapter 208 to facilitate the functionality of scenario extraction service 118. For example, service 118 may access vehicle data stored in non-volatile memory 204 in order to identify and extract events and/or scenarios from the data. Service 118 may then store data corresponding to the extracted events/scenarios back in non-volatile memory 204 in a separate format, separate location, separate directory, etc. The details of scenario extraction service 118 will be discussed in greater detail below.

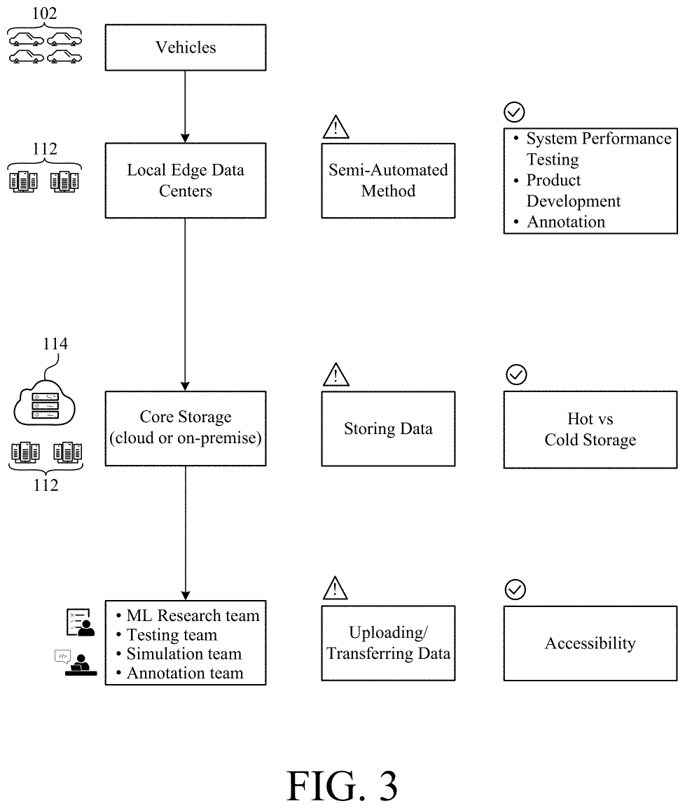

FIG. 3 is a data flow diagram showing data flow from autonomous vehicles 102 (and/or sensor units 104) to particular applications. Data is received from vehicles 102 at local edge data centers, which are located in relative proximity to the vehicles in the field. Hours of driving data is received from autonomous vehicles 102 at local edge data centers (e.g. data center 112) via network 110. This data includes raw sensor data (e.g., video data, lidar data, radar data, acceleration data, etc.), controller area network (CAN) bus data (e.g., diagnostic data), and map data (e.g., GPS coordinates, route data, etc.). A very large amount of data (e.g., petabytes, exabytes, etc.) is received from vehicles 102. However, the inventors estimate that only 5-10% of this data is useful.

An important advantage of example embodiments is the facilitation of extracting useful data from the large amount of data received from vehicle sensors without requiring manual (e.g., human) review. Useful events and scenarios are extracted from the received data via scenario extraction service 118 at data center(s) 112. This distinction between the extracted scenarios and the rest of the data is relevant when the data is provided to core storage (either in the cloud or on premise), because it allows the important data to be stored/organized in an access-efficient manner. In addition, service 118 can determine which scenarios need to be analyzed for system performance testing, which scenarios can be used by machine learning (ML) researchers for product development, and which scenarios must be sent out for annotation, among other things. This allows the relevant parties (e.g., ML researchers, testers, simulators, and/or annotators) to access the data that is most useful to them in an efficient manner.

The particular data flow shown in FIG. 3 is merely an illustrative example and is not intended to be limiting. As an example alternative, the sensor data received from autonomous vehicles could be provided directly to cloud storage, with the extraction service fetching the data from the cloud before analysis. Additionally, the scenario extraction service could utilize application programming interfaces (APIs) to access and extract the important scenarios directly from the cloud. In still another alternative, the scenario extraction service could be deployed directly on the cloud, with the extracted scenarios being provided to the on premise data storage most conveniently available to the relevant parties. As yet another alternative, the extraction service could be provided on board the autonomous vehicle. These and other alternatives will be apparent to those skilled in the art, particularly in view of the present disclosure.

From core storage, the events and scenarios can be provided to or accessed by developers in order to facilitate the development of autonomous vehicle technology. The events and scenarios can also be provided to datasets for tests and training in simulations. The events/extracted scenarios can be utilized to generate simulations for testing various aspects of autonomous vehicle software, such as computer vision, collision avoidance, etc. For example, an extracted scenario can be utilized to fabricate realistic sensor data corresponding to a particular event occurring in a simulation. Extracted scenarios can also be utilized as training datasets in machine-learning applications. They can also be utilized for testing current autonomous/semi-autonomous vehicle systems, including, for example, perception technology.

In addition to determining what portion of the bulk vehicle data represents scenarios of interest, scenario extraction service 118 can also determine which events/scenarios are relevant to various researchers, users, actuaries, etc. By way of non-limiting example, a scenario that involves a rear-end collision could be directed toward researchers who are developing improvements in autonomous vehicle software relevant to avoiding such collisions. As another example, extracted scenarios may be provided for annotation (e.g., to identify objects represented in the data) by researchers developing computer vision. It will be apparent to individuals having ordinary skill in the art, particularly in view of the present disclosure, that the events and/or scenarios may be utilized for wide-ranging purposes.

FIG. 3 illustrates some of the key advantages of the present embodiment. Vehicle data corresponding to the extracted scenarios is handled differently from the bulk vehicle data. Therefore, important data can be identified, uploaded, and made accessible immediately. In prior art systems, all of the data from the vehicles is uploaded or otherwise transferred, which often takes weeks. This delay causes losses in development time and revenue. In contrast, extracted scenarios can be uploaded and/or downloaded more quickly, because they represent only a subset of the bulk vehicle data. Similarly, the data corresponding to the extracted scenarios can be prioritized for upload to collaborative data stores. In addition, more accessible forms of storage can be prioritized for storing the extracted scenarios and the bulk vehicle data can be stored in less accessible forms of storage or, optionally, deleted. As yet another example, the extracted scenarios can be prioritized for storage in more expensive storage locations, because it costs less to store the smaller data sets. The example embodiment provides an implementation that is up to eighty times faster and up to twenty times cheaper than prior manual review. In comparison, the prior art systems are slow and expensive, and may miss important scenario types.

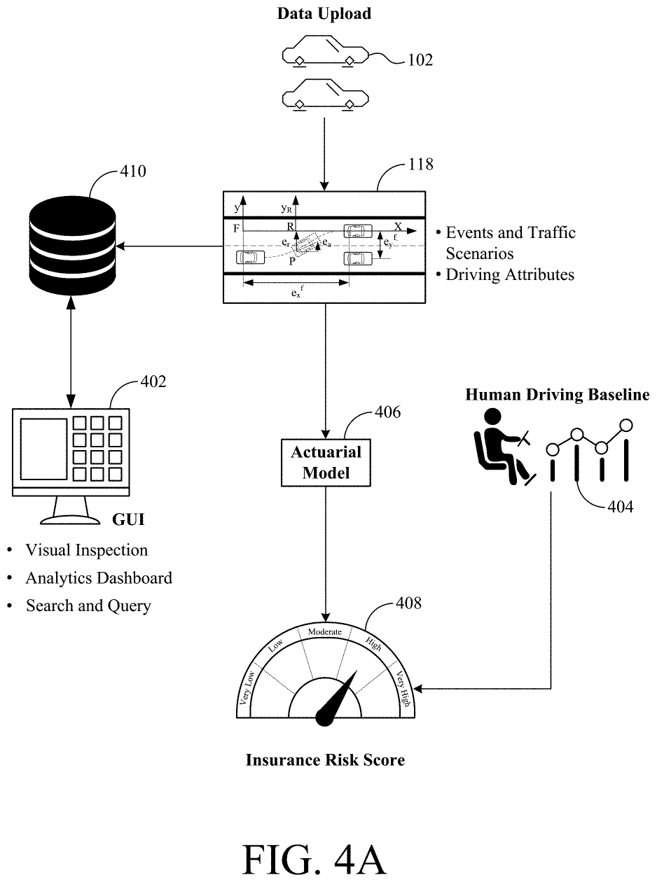

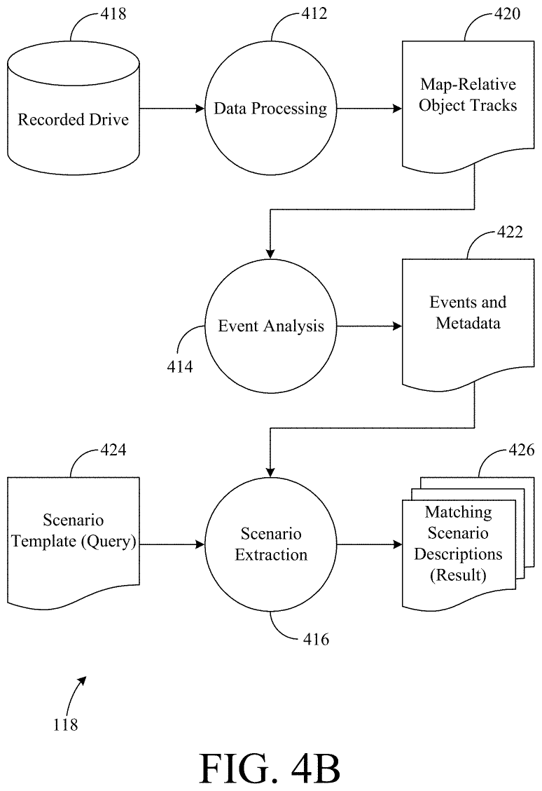

FIG. 4A is another data flow diagram showing example data flow from autonomous vehicles to utilization in insurance risk scoring and display via a graphical user interface (GUI) 402. The raw sensor data is uploaded from vehicles 102, and analyzed by scenario extraction service 118. Scenario extraction service 118 analyzes the data to, in part, determine the movements of the vehicles 102 as well as other vehicles, pedestrians, animals, objects, etc. detected by the vehicle's sensors. The scenario extraction tool can then determine from the data what type of interaction occurred, how the vehicle responded, etc. In particular, scenario extraction service 118 utilizes some combination of the driving data, GPS data, map data, additional driving data (e.g. from another vehicle in a fleet), and/or appropriate transformations (e.g., to account for camera lens characteristics) to track the two dimensional location of objects in a scene. For example, the scenario extraction service 118 can utilize the sensor data to determine that one of vehicles 102 approached another vehicle from behind, changed lanes, and overtook the vehicle. This scenario is represented by a constant change in the relative locations between the vehicles along the x direction (representing one vehicle overtaking the other) and a relatively abrupt change in the locations between the vehicles along the y direction (representing one vehicle changing lanes while the other remains in the original lane). This data then represents an important traffic scenario (e.g., passing another vehicle).

Extraction service 118 can also determine driving attributes associated with vehicles 102. For example, if the data received from a particular one of vehicles 102 indicates that vehicle 102 often accelerates and/or decelerates too quickly, this vehicle and/or an associated driver could be tagged as aggressive. The events and traffic scenarios are then combined with a human driving baseline 404 by an actuarial model 406 to determine a risk score 408 for the vehicle and/or a particular driver. The risk score can be utilized, for example, to set insurance rates for the vehicle and/or the particular driver.

The scenario extraction service 118 also provides at least a portion of the data associated with extracted scenarios to GUI 402, via a database 410. Database 410 stores the extracted scenarios (and/or, pointers to the extracted scenarios, metadata, etc.) in a queryable format. GUI 402 accesses database 410 in order to provide an interface to human users for visually inspecting video data corresponding to scenario clips, interacting with analytics corresponding to the extracted data, and for searching and querying the data (e.g., to find events, to find a particular type of scenario, scenarios involving a particular vehicle, and so on), among other things. GUI 402 allows users, such as machine learning researchers, to identify relevant scenarios, for example all scenarios involving a passing situation. Thus, GUI 402 advantageously provides a means for users to access a large amount of real-world driving data corresponding to particular, relevant traffic scenarios.

FIG. 4B is a data flow diagram illustrating a method for extracting scenarios from the driving data. Scenario extraction service 118 includes a data processing module 412, an event analysis module 414, and a scenario extraction module 416. Data processing module 412 retrieves driving data from a recorded drive database 418 and processes the retrieved data to identify objects represented in the data and track the location of the objects. Data processing module 412 produces map-relative object tracks 420. Event analysis module 414 utilizes map-relative object tracks 420 to identify traffic events 422, which are saved along with corresponding descriptive metadata. Events and metadata 422 is utilized by scenario extraction module 416 along with a scenario template 424 to generate matching scenario descriptions 426.

In the example embodiment, a “functional scenario” is a generalized description of a driving scenario that covers a space of variations or “concrete scenarios”. In the example system, a functional scenario description serves two important roles that are complementary to each other, which include utilizing a scenario description as a template for query (e.g. template 424) and utilizing a scenario description to represent the results of a query (e.g., descriptions 426). In the first example, a scenario description can serve as a template for querying for situations that match a desired spatio-temporal structure. The example system can parse such a description, understand the desired structure, and find matching scenarios from real-world data.

Similarly, a scenario description can represent a match (i.e., a search result) to a desired template 424. The same format can be used to represent the results of such a query, where each matching real-world scenario is described with additional detail pertaining to that specific instance. In order to synthesize a functional scenario description for any observed scenario, the example scenario extraction pipeline extracts all necessary events, metadata and parameters at different stages of the pipeline. This dual use of scenario descriptions is critical for bridging the gap between scenarios observed in the real world and those produced in a simulation environment, and is a novel aspect of the example system.

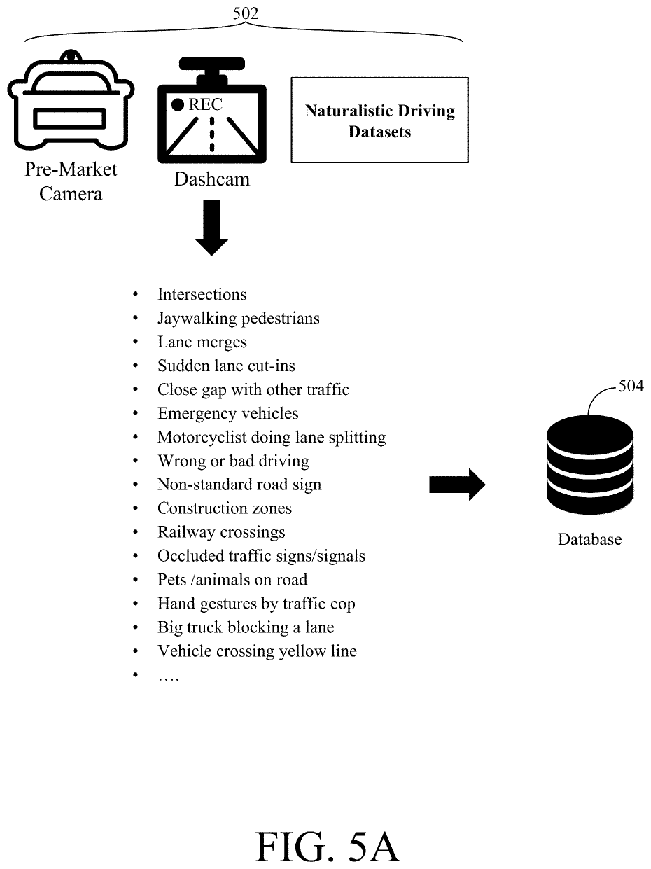

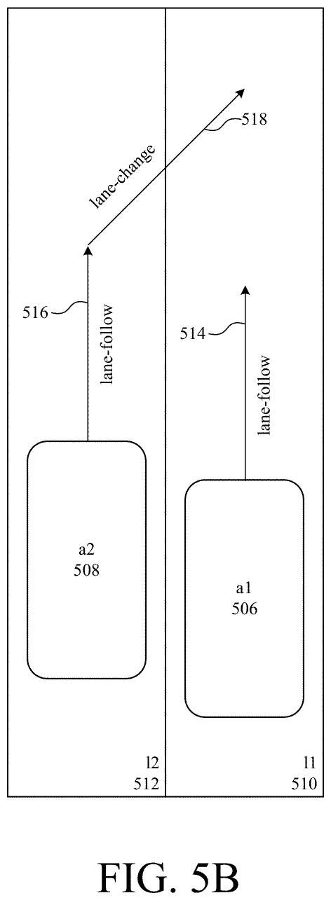

FIG. 5A is a data flow diagram showing example categories of traffic events and/or scenarios that can be stored in a database. According to an example system, vehicles equipped with dashcams, cameras, and/or ADAS systems can be converted into data collection units 502. These vehicles are also provided with a communications device, such as a wireless cell modem (if they do not already include one) and software for providing video and/or sensor data to data center(s) 112 over a wireless network. These outfitted vehicles can be utilized to collect data indicative of a multitude of real-world scenarios at a fraction of the typical cost. The data can cover millions of miles across multiple geographies, weather conditions, and road types. Such data could be utilized for developing systems and methods for overcoming the difficulty of autonomous vehicles to navigate in inclement weather, for example.

Upon analysis by scenario extraction service 118, portions of the data received from vehicles 102 are isolated and stored in a database 504 alongside descriptive metadata. Alternatively, the data received from vehicles 102 may be stored elsewhere, while database 504 stores pointers to particular sections of the data corresponding to the extracted scenarios. The descriptive metadata includes various tags indicative of the stored scenarios, which include, but are not limited to, scenarios involving intersections, jaywalking pedestrians, lane merges, sudden lane cut-ins, close gaps with other traffic, emergency vehicles, motorcyclists doing lane splitting, poor driving, non-standard road signs, construction zones, railway crossings, occluded traffic signs/signals, animals in the road, hand gestures by traffic cops, trucks blocking a lane, vehicles crossing a yellow line, oversized vehicles, etc. The various scenarios can be filtered, sorted, queried, etc. across multiple dimensions through utilization of the metadata.

FIG. 5B is a sample visualization of a cut-in scenario. The scenario describes a first vehicle 506 and a second vehicle 508. First vehicle 506 travels in a first lane 510, while second vehicle 508 travels in a second lane 512. First vehicle 506 exhibits a “lane-follow” event 514, by remaining in first lane 510. Second vehicle also exhibits a “lane-follow” event 516 by remaining in second lane 512, before exhibiting a “lane-change” event 518, by travelling from second lane 512 and into first lane 510. Together, events 514, 516, and 518 constitute a cut-in scenario.

Below is a sample scenario template (describing the above cut-in scenario) used to search for real-world scenarios in the driving data:

```
!Scenario
header: !Header
  name: template-0
environment: !Environment
  weather: sunny
road_network: !RoadNetwork
  nodes:
      - !Node
        name: 11
        type: Lanelet
      - !Node
        name: 12
        type: Lanelet
  edges:
      - !Edge
        from: 11
        to: 12
        type: right
actors:
  - !Actor
    name: a1
    type: vehicle
    behavior: !Behavior
      name: a1/lane-follow
      type: LaneFollow
      target: 11
  - !Actor
    name: a2
    type: vehicle
    behavior: !Sequence
      behaviors:
          - !Behavior
            name: a2/lane-follow
            type: LaneFollow
            target: 12
          - !Behavior
            name: a2/lane-change
            type: LaneChange
            target: 11
  relationships:
      - a2/lane-follow =before=> a2/lane-change
      - a1/lane-follow =during=> a2/lane-follow.
```

Scenario extraction module 416 searches within the events and metadata to find one or more events within a particular time period that match the events specified in scenario template 424. It should be noted that scenario template 424 may include more, fewer, and/or different events and other constraints. For example, a functional scenario description may indicate that a vehicle decelerates rapidly. In such a case, matching scenario descriptions 426 will include only scenarios in which one or more of the vehicles decelerates rapidly. The exact contents of scenario template 424 depends on the discretion of the researchers and, therefore, may be tailored to match scenarios as general or as specific as required by the use-application.

Below is an example of a matched scenario description 426, generated from real-world data (e.g., a particular instance of the scenario, using the same format, but with additional detail):

```
!Scenario
header: !Header
  name: template-0_result-0
environment: !Environment
  weather: sunny
  time_of_day: afternoon
road_network: !RoadNetwork
  nodes:
    - !Node
      name: 11
      type: Lanelet
    - !Node
      name: 12
      type: Lanelet
  edges:
    - !Edge
      from: 11
      to: 12
      type: right
    - !Edge
      from: 12
      to: 11
      type: left
actors:
    - !Actor
      name: a1
      type: vehicle
      state: !State
      frame: 11
      pose: !Pose
        position: !FrenetPosition
        s: 5.2
        1: 0.3
      behavior: !Behavior
        name: a1/lane-follow
        type: LaneFollow
        target: 11
        speed: 14.6
    - !Actor
      name: a2
      type: vehicle
      state: !State
      frame: 12
      pose: !Pose
        position: !FrenetPosition
        s: 10.6
        1: -0.7
      behavior: !Sequence
      behaviors:
        - !Behavior
          name: a2/lane-follow
          type: LaneFollow
          target: 12
          speed: 21.2
        - !Behavior
          name: a2/lane-change
          type: LaneChange
          target: 11
          speed: 25.3
relationships:
  - a1/lane-follow =during=> a2/lane-follow
  - a2/lane-follow =before=> a2/lane-change
  - a1/lane-follow =during=> a2/lane-change
```

The example matched scenario description has the same general format as the example scenario template, but has additional details that describe the real-world event more specifically. For example, the matched scenario description includes position information corresponding to the vehicles. Despite these differences in specificity, the scenario template and the matched scenario description both correspond to a cut-in scenario.

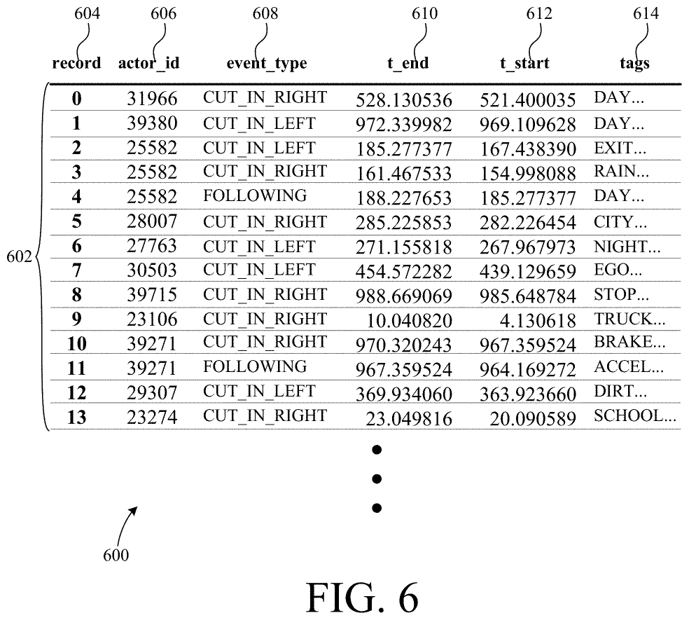

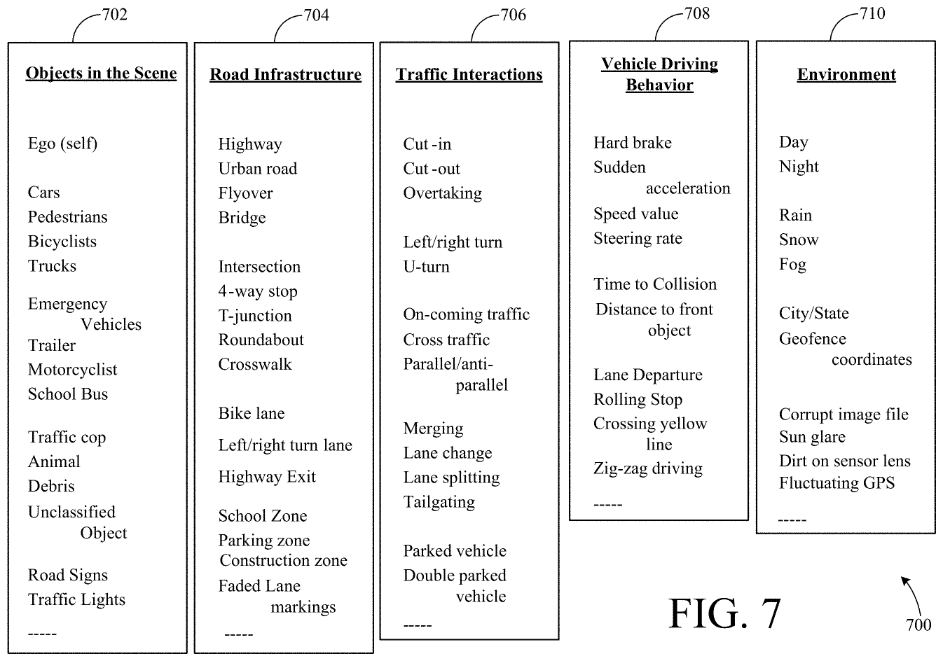

FIG. 6 shows a table 600 including example records 602 corresponding to extracted scenarios stored in database 410 for search, query, and retrieval. Table 600 includes a “record” column 604, an “actor_id” column 606, an “event_type” column 608, a “t_end” column 610, a “t_start” column 612, and a “tags” column 614. Each of records 602 corresponds to a particular extracted scenario and includes an entry in each of columns 604-614. Entries in “record” column 604 include a unique identifier corresponding to a particular one of records 602. Entries in “actor_id” column 606 include a number indicative of a particular vehicle and/or driver associated with the particular scenario. Additionally, entries in columns 604 and/or 606 can be utilized to identify file names, storage locations, etc., that correspond to vehicle data associated with the vehicle/driver identified by the entry or to the matched scenario description that corresponds to the particular scenario. Entries in “event_type” column 608 include a tag indicative of a particular scenario type. Entries in “t_end” column 610 include a number indicative of an end time of the corresponding scenario within a time stamped stream of vehicle data. Entries in “t_start” column 612 include a number indicative of a start time of the corresponding scenario within the same time stamped stream as the end time indicator. Finally, entries in “tags” column 614 include metadata tags (shown in FIG. 7) that describe the extracted scenario.

Table 600 illustrates metadata associated with particular extracted scenarios. The metadata may be utilized to search, filter, query, and retrieve particular scenarios and/or scenarios corresponding to certain scenario types, including certain vehicles (and/or drivers), occurring at certain times, including certain event-types, etc. The metadata allows interested parties (e.g., machine learning researchers) to quickly access and retrieve scenarios that are highly relevant to their work and, therefore, are valuable to them. Table 600 is illustrative only, and is not intended to show an exhaustive list of possible database entries. In particular, alternative metadata tables may include more and/or different column types, including, for example, entries indicative of particular vehicle models, data storage locations, autonomous driving systems, and so on.

FIG. 7 is a table 700 illustrating example metadata tags for searching, sorting, and filtering through extracted traffic scenarios. Table 700 includes various metadata tags that are utilized to describe components that are present in a particular traffic scenario. The tags are organized into categories, including, but not limited to, objects in the scene, road infrastructure, traffic interactions, vehicle driving behavior, and environment. Objects in the scene category 702 includes tags that identify various objects that may be present in a traffic scenario. Tags in category 702 include, but are not limited to, ego (self), cars, pedestrians, bicyclists, trucks, emergency vehicles, trailers, motorcyclists, school busses, traffic cops, animals, debris, unclassified objects, road signs, and traffic lights. Road infrastructure category 704 includes tags that identify various forms of road infrastructure that may be involved in a traffic scenario. Tags in category 704 include, but are not limited to, highway, urban road, flyover, bridge, intersection, 4-way stop, T-junction, roundabout, crosswalk, bike lane, turn lane, highway exit/entrance, school zone, parking zone, construction zone, and faded lane markings. Traffic interactions category 706 includes tags that identify various traffic interactions (scenarios or events) that may occur in a traffic scenario. Tags in category 706 include, but are not limited to, cut-in, cut-out, overtaking, left/right turn, U-turn, on-coming traffic, cross traffic, parallel/anti-parallel, merge, lane change, lane splitting, tailgating, parked vehicle, and double-parked vehicle. Vehicle driving behavior category 708 includes tags that identify particular driving behaviors that may be exhibited by a vehicle/driver during a traffic scenario. Tags in category 708 include, but are not limited to, hard brake, sudden acceleration, speed value, steering rate, time to collision, distance to front object, lane departure, rolling stop, crossing yellow line, and zig-zag driving. Environment category 710 includes tags that identify various environmental conditions that may apply to a traffic scenario. Tags in category 710 include, but are not limited to, day, night, rain, snow, fog, city/state, geofence coordinates, corrupt image file, sun glare, dirt on sensor lens, and fluctuating GPS.

The metadata tags are listed within metadata (e.g., in database 410) associated with the underlying vehicle data or matched scenario description corresponding to an extracted traffic scenario. These tags are utilized to search and filter through the underlying data to identify traffic scenarios that are relevant to a user. For example, a traffic scenario involving a vehicle cutting off the ego vehicle while entering a highway might include tags such as ego, car, highway, highway entrance, cut-in, merging, hard brake, and day, among others. A user can find the example traffic scenario by doing a Boolean search for any relevant combination of the metadata tags. For example, a search for “car OR night” would return the example scenario, whereas a search for “car AND night” would not. In other words, a user could search any combination of metadata tags and GUI 402 will return every scenario matching the combination.

In addition, some metadata tags include associated values. For example, the “speed value” tag includes a value indicative of an average speed, maximum speed, minimum speed, change in speed, etc. associated with one or more objects in the example traffic scenario. These values can also be searched, sorted, filtered, etc. For example, traffic scenarios can be sorted based on the speed of the ego vehicle at the start of the scenario, either descending from high speeds or ascending from a stop.

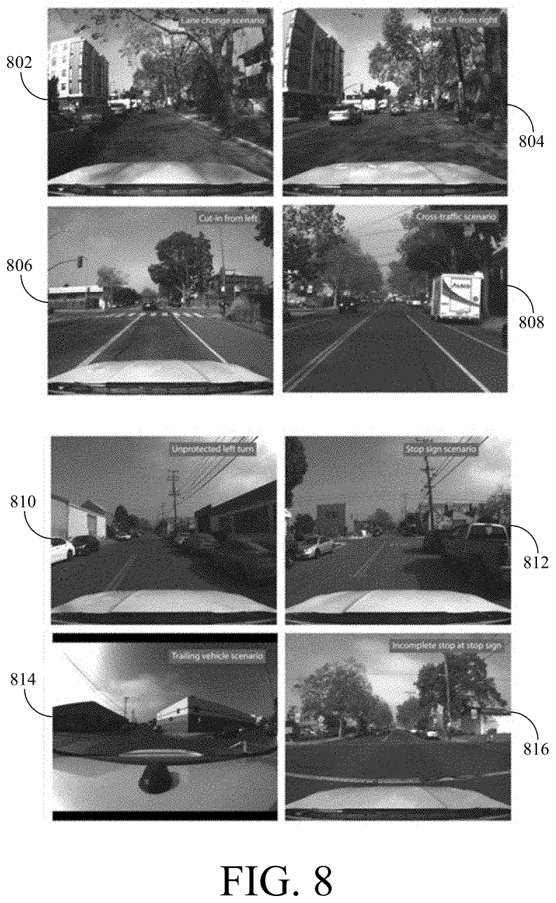

FIG. 8 is a collection of photographs from the perspective of the ego vehicle illustrating various scenarios that occur during operation of a vehicle. A first photograph 802 shows a lane change scenario. A second photograph 804 shows a cut-in from right scenario. A third photograph 806 shows a cut-in from left scenario. A fourth photograph 808 shows a cross-traffic scenario. A fifth photograph 810 shows an unprotected left turn scenario. A sixth photograph 812 shows a stop sign scenario. A seventh photograph 814 shows a trailing vehicle scenario. An eighth photograph 816 shows an incomplete stop at stop sign scenario.

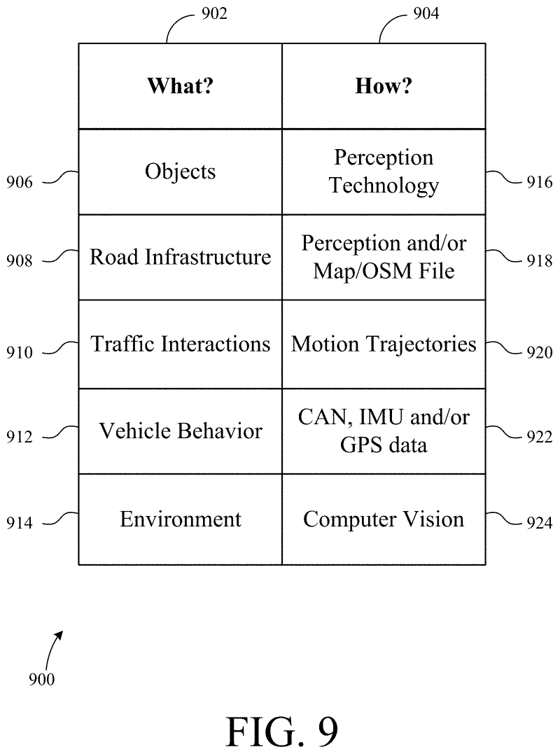

FIG. 9 is a table 900 showing example components of a traffic scenario and example explanations of how the example components are captured in and/or extracted from the data. A first column 902, labeled “What?”, includes possible components of a traffic scenario, and a second column 904, labeled “How?”, includes possible methods for identifying the components in a corresponding row of column 902. Column 902 includes, an objects category 906, a road infrastructure category 908, a traffic interactions category 910, a vehicle driving behavior category 912, and an environment category 914. Column 904 includes a perception technology category 916, a perception and/or Map/OSM file category 918, a motion trajectories category 920, a CAN, IMU, and/or GPS data category 922, and a computer vision category 924. Table 900 illustrates the methods available for collecting the various components of a traffic scenario. For example, the other objects in the scenario (category 906) and the road infrastructure (category 908) can be determined from perception technology (categories 916 and 918) (e.g., radar, LIDAR, camera data, etc.). Road infrastructure (category 908) can also be determined from GPS data, such as location data, and/or maps (category 918) (in an OpenStreetMap (OSM) format, for example). Traffic interactions (category 910) are identified by event analysis module 414 or scenario extraction module 416, which utilizes the relative motion trajectories of the objects in the scene (category 920). As an example, it can be determined that a vehicle has passed a particular one of vehicles 102 if the data shows the vehicle appear to the left and proceed forward. Vehicle driving behavior (category 912) can be determined for the vehicle 102 from CAN data, inertial measurement unit (IMU) data, and or GPS data (category 922). For example, IMU data can indicate that a vehicle is accelerating hard. The environment (category 914) can be determined using computer vision (category 924) and/or other sources (such as current/historical weather data available on the Internet).

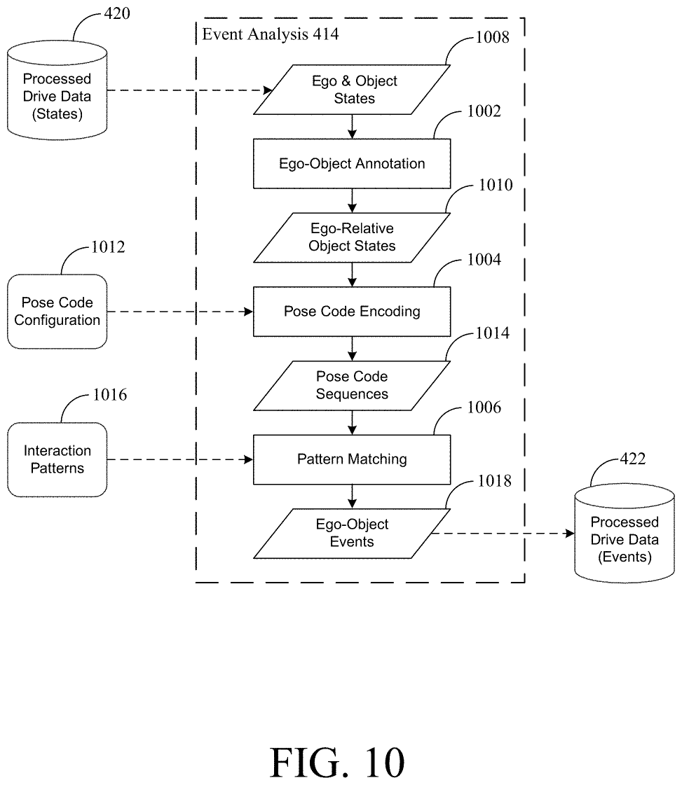

FIG. 10 is a data flow diagram illustrating an example method for capturing events from pre-processed vehicle driving data. The example method is performed by event analysis module 414, which includes an ego-object annotation service 1002, a pose code encoding service 1004, and a pattern matching service 1006. Ego-object annotation service 1002 acquires ego and object states 1008 (e.g., locations, headings, motion, etc. of the ego vehicle and other objects identified by the driving data) from processed drive data database 420. Service 1002 transforms the ego-object states 1008 from a global/absolute reference frame to an “ego-centric” reference frame in order to generate ego-relative object states 1010.

Pose code encoding service 1004 obtains ego-relative object states 1010 and utilizes a pose code configuration 1012 to encode the positions and orientations of objects into a simplified pose code. The position and orientation of each object is encoded for each unit of time, to generate pose code sequences 1014, which are indicative of the object's motion over time. Pose code sequences 1014 are processed by pattern matching service 1006 to identify ego-object events 1018. Interaction patterns 1016 are pre-defined patterns (e.g., scenario templates), which correspond to generalized traffic events. Pattern matching service 1006 matches sections of pose code sequences 1014 to particular ones of interaction patterns 1016 to identify real-world instances of traffic events captured by the driving data. Ego-object events 1018 are stored in processed drive data database 422.

Interactions between any two actors in traffic are important elements of a driving scenario. Identifying them and quantifying the metrics associated with each event (including relative positions, velocities, etc.) facilitates the recreation of the same situations in simulation, as well as the production of meaningful variations. The novel approach to interaction analysis includes jointly finding and classifying different spatio-temporal interactions in sequences of driving data between two actors, using an efficient algorithm that scales linearly with the length of the input sequence.

Interaction analysis is performed from the perspective of a reference object or “ego”, looking at other objects or actors as they carry out different maneuvers. The input to this process is a sequence of ego and object states, including (at least) their position and orientation at each instant of time. Each stage of processing is further explained below.

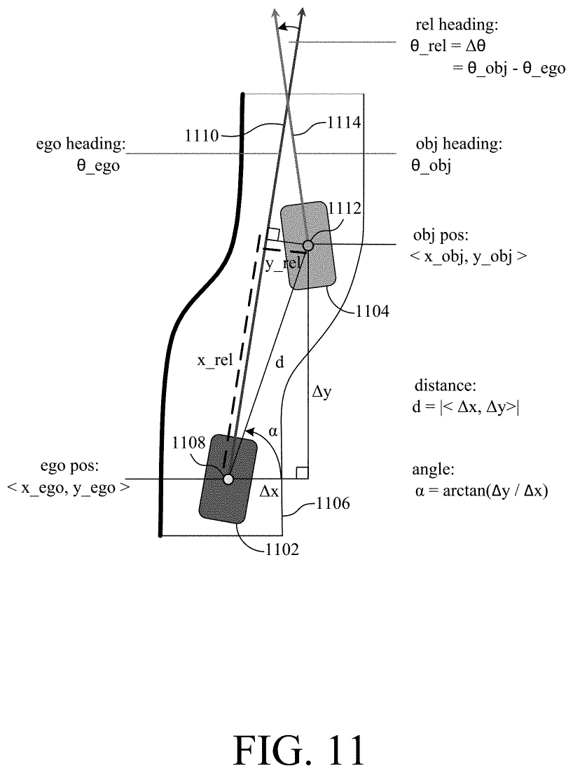

FIG. 11 is a diagram showing the relative positions and headings of two vehicles on a roadway. An ego vehicle 1102 and an object vehicle 1104 are positioned on a roadway 1106. Ego vehicle 1102 exhibits an ego position 1108 (“<x_ego, y_ego>”) and an ego heading 1110 (“θ_ego”). Object vehicle 1104 exhibits an object position 1112 (“<x_obj, y_obj>”) and an object heading 1114 (“θ_obj”). A difference (“<x_rel, y_rel>”) between ego position 1108 and object position 1112 can be identified, as well as a difference (“θ_rel”) between ego heading 1110 and object heading 1114.

At this stage, ego-object annotation service 1002 converts global/absolute object positions to ego-relative object positions, along with additional states such as orientation and velocity, together comprising ego and object states 1008 and ego-relative object states 1010, respectively. The absolute position and orientation of the ego (“<x_ego, y_ego, θ_ego>”) is used as a moving reference frame. The position and orientation of the object (“<x_obj, y_obj, θ_obj>”) are transformed with respect to this frame, producing ego-relative position and orientation (<x_rel, y_rel, rel>). This process is repeated for each time instant (t) for which we have available data, and for each object to be encoded.

FIG. 12 is a collection of photographs illustrating visual processing utilized for event analysis. Bounding boxes in the picture identify objects in the vicinity of the ego vehicle including other vehicles, traffic lights, road signs, etc. In the example embodiment, these bounding boxes are generated by data processing module 412 through computer vision techniques and utilized to track motion trajectories for identifying traffic events. Visually processing video data received from vehicles 102 allows useful events and scenarios to be extracted from data received even from non-autonomous vehicles (e.g., a cab with a dashcam). These events can be utilized for productive purposes even without accompanying sensor data, such as LIDAR data. More information regarding computer vision in autonomous vehicles can be found in U.S. Provisional Patent Application No. 63/158,093, filed on Mar. 8, 2021 by Kumar et al., which is incorporated herein by reference in its entirety.

A first photograph 1202 shows a vehicle on a multi-lane highway. Bounding boxes 1204 identify other vehicles on the highway. Bounding boxes 1204 are utilized by ego-object annotation service 1002 to generate ego-relative object states 1010. States 1010 can then be utilized with or without additional data to determine if the corresponding vehicles change lanes, slow down, accelerate, get on/off the highway, etc.

A second photograph 1206 shows a vehicle at a large intersection. Bounding boxes 1208 identify other vehicles at the intersection, and bounding boxes 1210 identify traffic lights at the intersection. Bounding boxes 1208 and corresponding ego-relative object states can be tracked to determine if the corresponding vehicles turn, drive through the intersection, stop, etc. Bounding boxes 1210 and the corresponding ego-relative object states 1010 can be utilized to determine proper/improper vehicle behavior in the intersection, ego vehicle movement, etc.

A third photograph 1212 shows a vehicle at a smaller intersection. Bounding boxes 1214 identify other vehicles at the intersection, bounding boxes 1216 identify traffic lights at the intersection, bounding boxes 1218 identify pedestrians at the intersection, and a bounding box 1220 identifies a fire hydrant near the intersection. Bounding boxes 1214 and the corresponding ego-relative object states 1010 can be utilized to determine if the corresponding vehicles turn, drive through the intersection, stop, etc. Bounding boxes 1216 and the corresponding ego-relative object states 1010 can be utilized to determine proper/improper vehicle behavior in the intersection, ego vehicle movement, etc. Bounding boxes 1218 and the corresponding ego-relative object states 1010 can be utilized to determine if pedestrians cross at the crosswalk, wait to cross, jaywalk, etc. Bounding box 1220 and the corresponding ego-relative object states 1010 can be utilized to determine ego vehicle movement, etc.

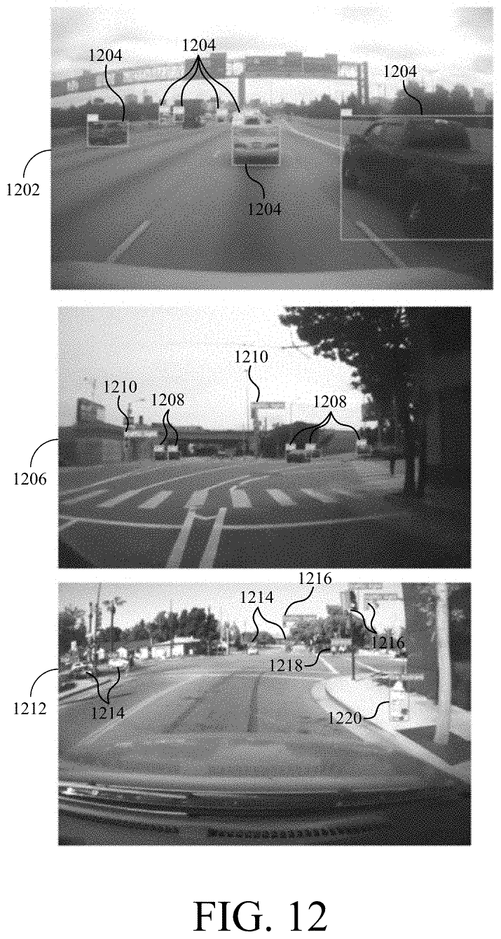

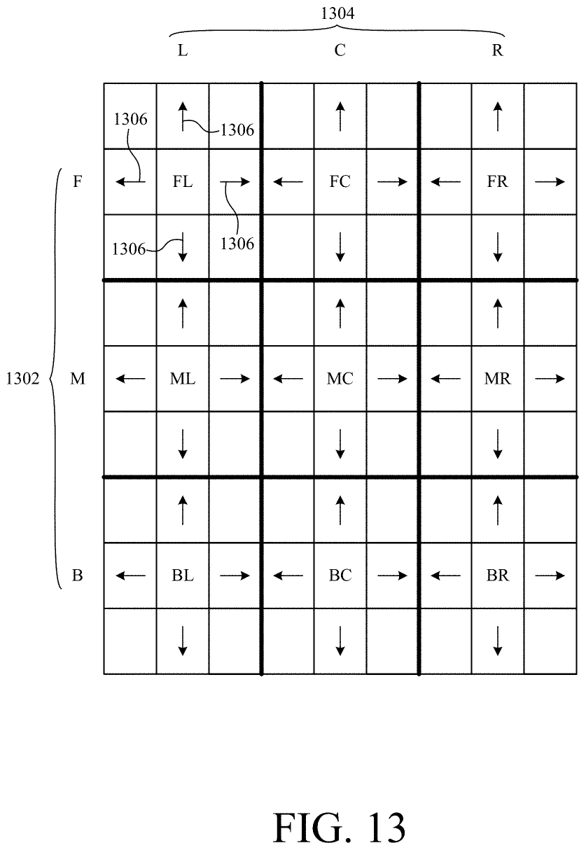

FIG. 13 is a table illustrating the pose code configuration 1012. Sequences of ego-relative positions and orientations are encoded by mapping to several predefined regions around the ego vehicle. The extents and shapes of these regions may be defined by a customizable pose code configuration file. In this example configuration, longitudinal positions are bucketed into one of three rows 1302, forming the first letter of the pose code: F (front), M (middle) or B (back). Similarly, lateral positions are bucketed into three columns 1304, forming the second letter: L (left), C (center) or R (right). In addition, the relative orientation of the object is bucketed into one of 4 directions 1306 (relative to the ego): N↑ (north, i.e. facing the same direction as ego), S↓ (south), E→ (east, to the right), or W← (west).

In the example embodiment, the ego vehicle is always present in the Middle-Center region with an orientation of North, thus resulting in a pose code of “MCN”. An object directly in front would be encoded as “FCN”, one approaching perpendicular to the ego from the left would be encoded as “MLE”, etc. In alternate embodiments, in which an object other than the ego vehicle is utilized as the reference object, the ego vehicle may have differing pose codes, dependent on its position relative to the reference object.

A sequence of ego-relative object states, once encoded using the pose code scheme, produces a sequence of pose codes. For instance, a vehicle following behind ego will likely be encoded as a long sequence of “BCN_BCN_BCN . . . ”. A vehicle that starts out on the left side of ego (MLN) and then cuts into ego's lane in front (FCN) will likely result in a sequence such as “MLN_MLN . . . FCN_FCN_. . . ”. This insight is used to craft interaction patterns 1016, which are utilized by pattern matching service 1006 to identify events. A few such patterns are listed in the table below, expressed as regular expressions (modified to include desired repetition ranges, e.g. {10,20}):

| Interaction Type | Start Pose | Transient Pose | End Pose | Regular Expression |
|---|---|---|---|---|
| lead | FCN_ | | FCN_ | (FCN_){10,} |
| follow | BCN_ | | BCN_ | (BCN_){10,} |
| parallel:left | [FMB]LN_ | | [FMB]LN_ | ([FMB]LN_){10,} |
| parallel:right | [FMB]RN_ | | [FMB]RN_ | ([FMB]RN_){10,} |
| anti_parallel:left | [FMB]LS_ | | [FMB]LS_ | ([FMB]LS_){10,} |
| anti_parallel:right | [FMB]RS_ | | [FMB]RS_ | ([FMB]RS_){10,} |
| cut_in:from_left | MLN_ | [MF]LN_ | FCN_ | (MLN_) + ([MF]LN_) + (FCN_) |
| | | | | {10, 20} |
| cut_in:from right | MRN_ | [MF]RN_ | FCN_ | (MRN_) + ([MF]RN_) + (FCN_) |
| | | | | {10, 20} |

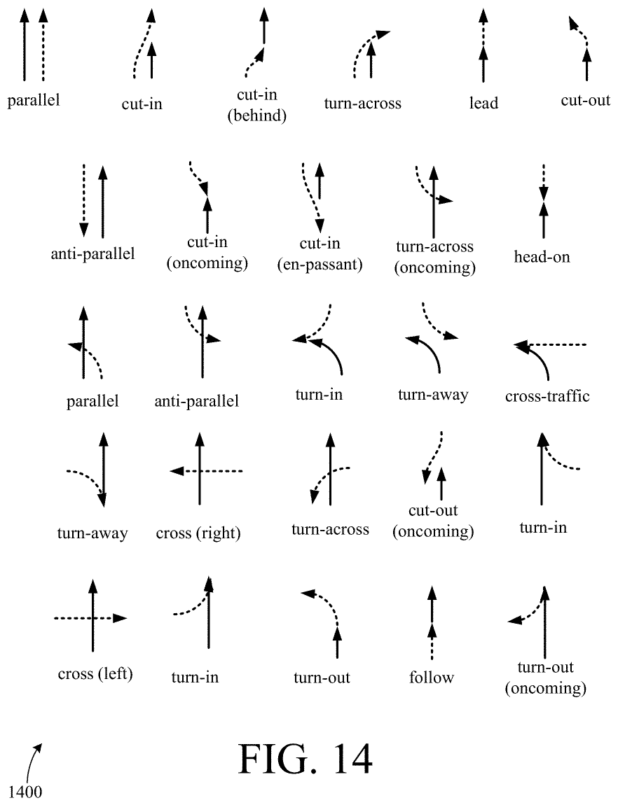

FIG. 14 is a diagram showing example traffic events 1400. Each of the traffic events (i.e. Object-Ego interactions-based scenarios) include an ego vehicle (i.e., the vehicle from which the corresponding data originates) and another vehicle. Each of events 1400 corresponds to one or more of interaction patterns 1016. The relative path taken by the vehicles are shown by the arrows, in which the ego vehicle is represented by the solid arrow and the adversary vehicle is represented by the dashed arrow. These traffic events are relevant to dynamic traffic interactions, pre-crash scenarios, and formal safety models, as non-limiting examples.

Traffic events 1400 are identified in the vehicle data by pattern matching service 1006 through the analysis of pose code sequences 1014 in view of interaction patterns 1016. For example, video data may show a vehicle change lanes in front of the ego vehicle. The video data is processed to generate a corresponding pose code sequence 1014. A standard regular expression pattern-matcher (e.g., pattern matching service 1006) is used to find occurrences of each of these patterns within pose code sequences 1014, thus both finding and classifying them by interaction type. Each matching result is used to obtain an event representation, identifying, for example, the category (“interaction”), type (“lead”, “follow”, etc.), t_start (starting timestamp of the match), t_end (ending timestamp of the match), and any additional metadata that maybe useful for further analysis, e.g. reference object ID (typically “ego”), actor ID that is performing the maneuver, etc. This information is illustrated in FIG. 6 and FIG. 7, for example.

Below is an example representation of an ego-object event 1018 in JSON format:

```
{
  “category”: “interaction”,
  “type”: “lead”,
  “t_start”: 5.1,
  “t_end”: 14.6,
  “metadata”: {
      “object_id”: “ego”,
      “actor_id”: “1001”
    }
}
```

By matching the generated pose code sequence 1014 to an interaction pattern 1016 corresponding to a “cut-in” event, the corresponding portion of the video data can be identified and classified as a “cut-in” event. Pattern matching service 1006 can tag any given section of data with one or more of traffic scenarios 1400. However, it is beneficial to utilize events 1400 as the basis for identifying and isolating sections of the data that may be of interest. For example, a section of data may include one vehicle leading another for some distance before exiting a highway. This section of data may be broken into two subsections: a first subsection labeled with a “lead” event and a second subsection labeled with a “cut-out” event.

Similar to ego-object annotation service 1002, the pattern matching step is performed for each ego-object pair, resulting in a collection of interaction events. This concludes the analysis process from one reference object considered as ego. The entire analysis may also be carried out from the perspective of different actors as ego, depending on the goal and scope of the analysis.

In addition to these, scenario extraction service 118 is able to identify surrounding traffic-based scenarios, map & infrastructure based scenarios, vehicle dynamics and self-maneuvers, and performance- and environment-based events. Scenario extraction service 118 provides a significant improvement over prior art systems by identifying an extensive and diverse set of events.

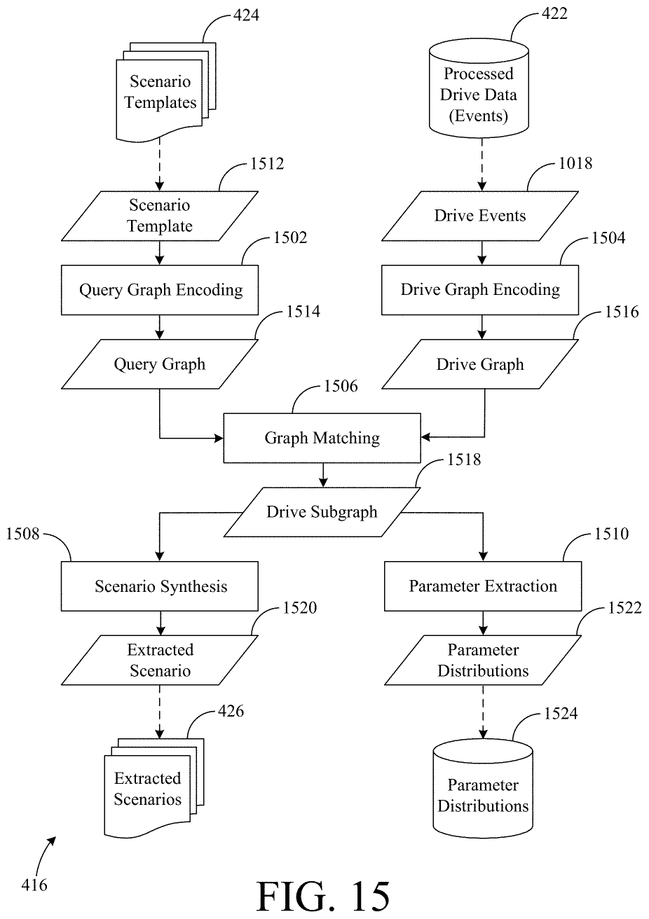

FIG. 15 is a data flow diagram illustrating an example method for extracting traffic scenarios from a collection of traffic events. A driving scenario may consist of a complex spatio-temporal combination of individual events and actor behaviors. For instance, a typical occurrence during traffic jams is that we find a vehicle in front (spatial relationship) that accelerates and then (temporal relationship) brakes suddenly. Or, while we are turning right at an intersection, a pedestrian starts crossing on a crosswalk that intersects with our path of travel.

Being able to extract such scenarios enables us to study the driving performance of humans as well as automated systems under different conditions. While it is possible to write individual programs that encode the logic to identify each such scenario, it is much more scalable to be able to describe a complex scenario in a declarative form, as in the example embodiment.

In order to enable this, the example embodiment includes a query engine that represents both the real-world data as well as a desired scenario template in the form of a graph, with nodes representing the different elements of the scenario and edges representing relationships between them.

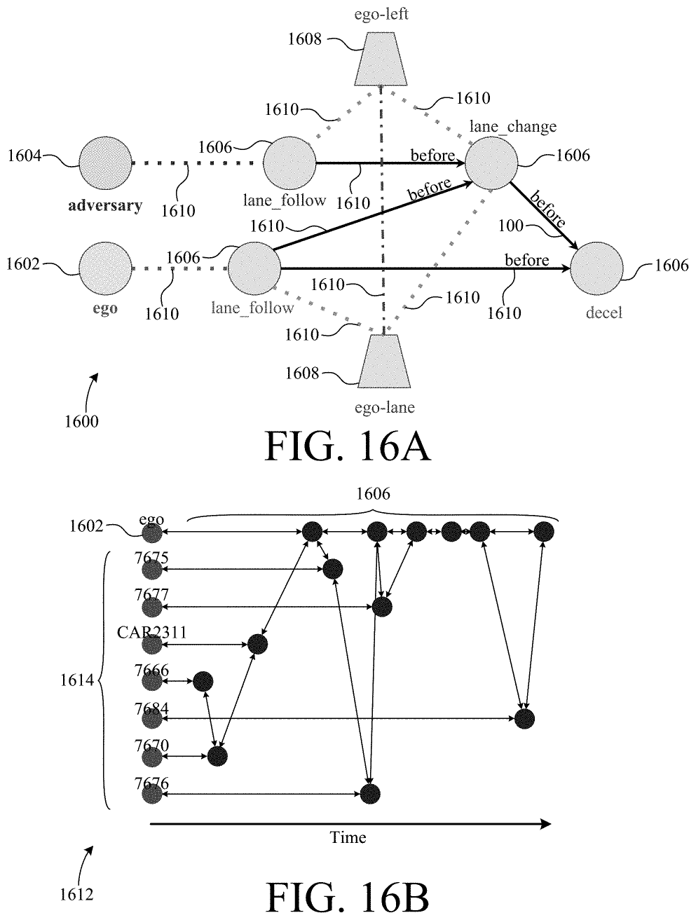

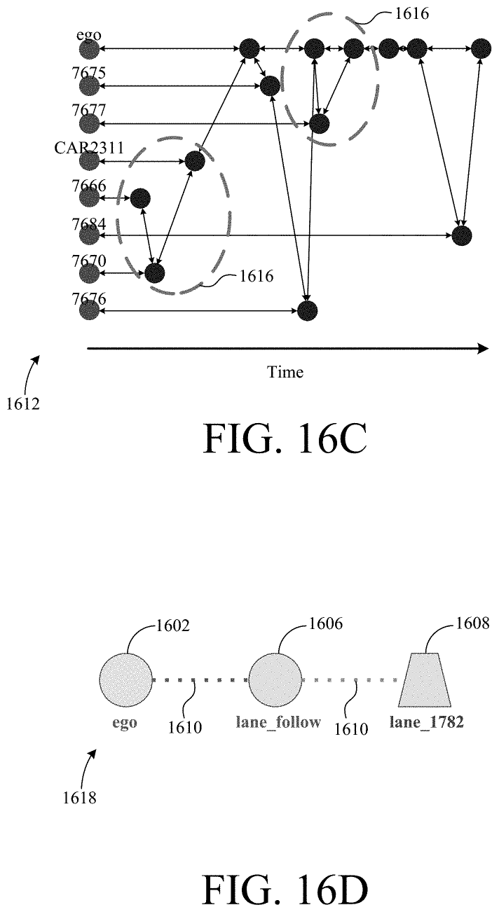

As shown in FIG. 15, scenario extraction module 416 includes a query graph encoding service 1502, a drive graph encoding service 1504, a graph matching service 1506, a scenario synthesis service 1508, and a parameter extraction service 1510. Query graph encoding service 1502 obtains a scenario template 1512, which is a generalized description of a desired traffic scenario. Service 1502 parses and transforms scenario template 1512 (e.g. a functional scenario description) into a query graph 1514 using a set of rules, which will be discussed in further detail with reference to FIGS. 16A-16D below.

Below is an example scenario template 1512:

| | |
|---|---|
| scenario: | |
| header: | |
| name: vehicle_cut-in-from- | |
| left_ego_decel | |
| description: Cut-in from left, then | |
| ego deceleration. | |
| tags: | |
| - map_track:Lanelet | |
| - objects:vehicle | |
| - Interaction:cut_in:from_left | |
| - ego:decel | |
| road_network: | |
| nodes: | |
| - name: ego-lane | |
| type: lanelet | |
| - name: ego-left | |
| type: lanelet | |
| edges: | |
| - from: ego-lane | |
| to: ego-left | |
| type: left | |
| actors: | |
| - name: ego | |
| start: ego-lane | # ego lane |
| behavior: | |
| - lane_follow: | # follow lane |
| - decel: | # decelerate |
| - name: adversary | |
| type: vehicle | |
| start: ego-left | # left-adjacent lane |
| behavior: | |
| - lane_follow: | |
| - lane_change: | |
| target: | |
| position: | |
| parent: ego-lane | # change into ego lane |
| s: Range(0, 25) | # relative to ego |
| relationships: | |
| - ego:lane_follow =before=> | |
| ego:decel | |
| - adversary:lane_follow = | |
| before=> adversary:lane_change | |
| - ego:lane_follow =before=> | |
| adversary:lane_change | |
| - adversary:lane_change = | |
| before=> ego:decel | |

Drive graph encoding service 1504 is similar to query graph encoding service 1502, except that drive graph encoding service 1504 generates a drive graph 1516 from drive events 1018, using similar rules as query graph encoding service 1502. Because drive events 1018 are, like scenario template 1512, encoded as functional scenario descriptions, drive graph 1516 is similar to query graph 1514. However, drive graph 1516 corresponds to real-life instances of traffic events, which are derived from the vehicle data. Therefore, drive graph 1516 is typically much larger and includes much more information than query graph 1514.

Graph matching service 1506 utilizes query graph 1514 and drive graph 1516 to identify drive subgraph(s) 1518 within drive graph 1516. Graph matching service 1506 finds instances within drive graph 1516 that match query graph 1514, according to graph topology, attributes, and/or parameters. Drive subgraph 1518 corresponds to a traffic scenario identified in the vehicle data encoded into drive graph 1516. The identified traffic scenario is comprised of a subset of events identified and classified by event analysis module 414. For example, drive graph 1516 may include a plurality of lane_follow, lane_change, deceleration, and/or acceleration events corresponding to an hour long drive. Subgraph 1518 then might include a lane_follow event, followed by a deceleration event, followed by a lane_change event, which together correspond to a traffic scenario (i.e. changing lanes to avoid a front-end collision) that occurred during some predefined maximum interval during said hour long drive.

Scenario synthesis service 1508 identifies each of subgraph 1518 and transforms the matched result back into a scenario description to generate a corresponding extracted scenario 1520. Scenario synthesis service 1508 maps each node of subgraph 1518 into an element of extracted scenario 1520. Additionally, service 1508 uses edges of subgraph 1518 to form implicit and explicit relationships between elements of extracted scenario 1520. Any unspecified information may be inferred from the matched events. For example, the starting position of each actor is derived from the first event encountered for that actor.

Parameter extraction service 1510 utilizes drive subgraph 1518 to generate parameter distributions 1522, which describe distributions of parameters associated with individual events of drive graph 1516. For example, parameter distributions 1522 may include a plurality of distances, which correspond to the distance between the ego vehicle and a lead vehicle at each lead event of drive graph 1516. Parameter distributions 1522 are stored in parameter distributions database 1524 and may be utilized to generate simulations, for example. Distributions 1522 are derived from real-world data and, therefore, provide a more accurate quantification of the operational design domain (ODD) within which a driving system must operate. Functional scenario descriptions when combined with distributions 1522 form “logical scenarios”. These logical scenarios can be sampled to produce many different meaningful variations of an observed scenario, thus enabling extensive testing and validation. For example, different values of a distance between an ego vehicle and a lead vehicle sampled from database 1524 may be utilized to simulate variations of a front-end collision scenario, in order to develop a function for identifying a safe following distance given a particular travel speed.

FIG. 16A is an example query graph 1600 generated by query graph encoding service 1502. Each object, road element, and distinct event in the scenario is represented as a node. In the example, an ego node 1602 and an adversary node 1604 correspond to the ego vehicle and an adversary vehicle, respectively. Event nodes 1606 correspond to events, such as lane_follow, lane_change, and decel. Element nodes 1608 correspond to road elements, such as ego-lane (i.e. the lane inhabited by the ego vehicle) and ego-left (i.e. the lane adjacent to the left of the ego-lane). Nodes 1602, 1604, 1606, and 1608 are connected by edges 1610 based on implicit and explicit relationships. For example, a lane_change event 1606 associated with the adversary vehicle would lead to an edge 1610 between the event 1606 and adversary node 1604 in the graph (implicit relationship). As another example, a lane_follow event 1606 that is specified to happen before a lane_change event 1606 (explicit relationship) would lead to an edge 1610 between the two events 1606.

Note that FIG. 16A shows only the topological information. Any additional attributes/parameters such as relative position values, velocities, etc. are associated with the corresponding nodes or edges, and can be used as additional constraints later in the matching stage.

FIG. 16B is an example drive graph 1612. Using rules similar to those utilized to generate query graph 1600, events detected from real-world driving data can also be encoded into a graph representation. For a typical driving session, this graph can be expected to have a fairly large number of nodes and edges. Graph 1612 includes ego node 1602, event nodes 1606, a plurality of object nodes 1614, and a plurality of edges (not labeled). It should be noted that event details and map elements have been omitted for clarity.

FIG. 16C is an example annotated version of the drive graph of FIG. 16B illustrating subgraphs 1616. Subgraphs 1616 are particular instances of encoded query graphs 1514, which correspond to particular driving scenarios identified in drive graph 1612. Encoded drive graph 1612 is loaded into a scalable graph database (e.g. graph matching service 1506) which supports matching based on topological as well as property-based constraints. The encoded query graph 1616 is then supplied as an input to a matching algorithm that finds instances of query graph 1616 that occur within the larger drive graph 1612.

Each matched result (i.e. subgraph 1616 within drive graph 1612) is transformed back into a scenario description by mapping each node 1606 into a scenario element and using edges 1610 to form implicit and explicit relationships.

FIG. 16D is an example fragment 1618 of a matched drive graph. In the example embodiment, fragment 1618 is transformed into the following scenario fragment:

```
scenario:
  ...
  actors:
  - name: ego
    ...
    behavior:
    - lane_follow:
      target:
        position:
          parent: lane_1782
          ...
```

All such fragments are composed together to form the complete scenario representation. Any unspecified information is inferred from the matched events, e.g. the starting position of each actor is derived from the first event encountered for that actor.

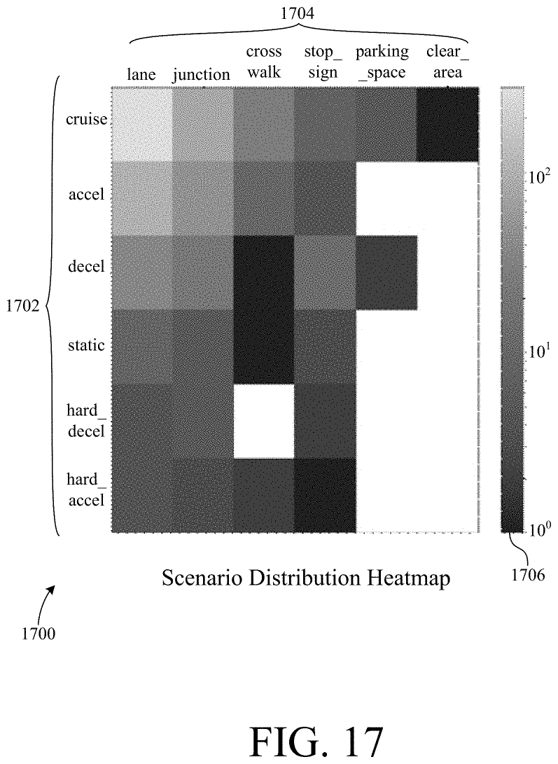

FIG. 17 is a heat map 1700 showing vehicle motion scenarios 1702 against different map areas 1704. Heat map 1700 is generated, for example, by parameter extraction service 1510, by identifying an acceleration parameter to events corresponding to particular road elements. The vertical axis is labeled with various scenarios 1702 including, from top to bottom, cruise, accel, decel, static, hard_decel, and hard_accel. The horizontal axis is labeled with various map areas 1704 including, from left to right, lane, junction, crosswalk, stop_sign, parking_space, and clear area. The gray-scaled blocks at the intersection of each pair of scenarios 1702 and map areas 1704 illustrate how often the given scenario has occurred in the given map area by any of a desired subset of vehicles 102. A number scale 1706 is shown to the right of heat map 1700, and is a logarithmic scale extending from 10° to just above 10². Heat map 1700 shows, for example, that cruising within a lane is very common, while hard accelerations at a stop sign is very uncommon. Heat map 1700 may show how often a given action has occurred in a given map area, how much time a given action has occurred for in a given map area, etc.

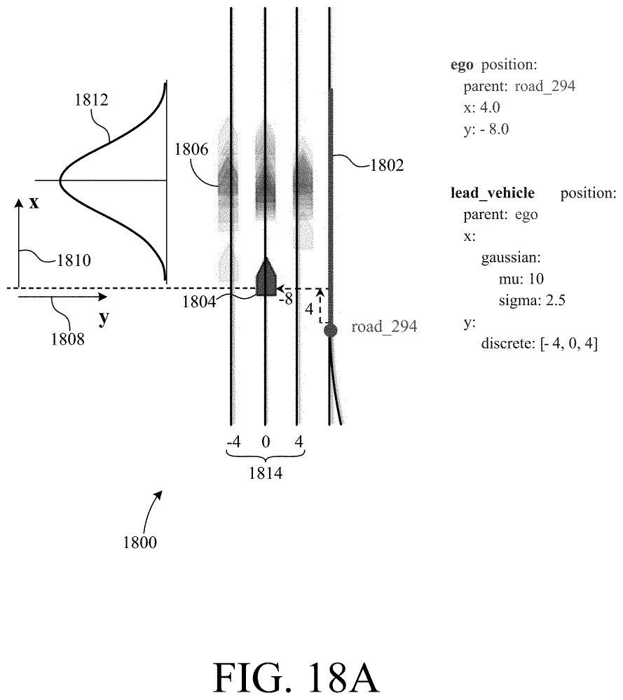

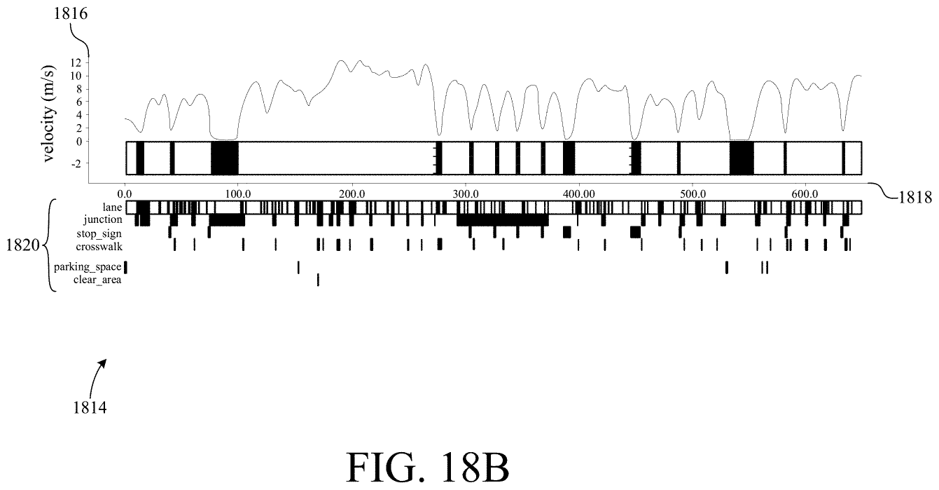

FIG. 18A is a diagram 1800 illustrating a method of utilized by parameter extraction service 1510. In addition to synthesizing individual scenarios, it is also important to consider the parameters associated with individual events and how they are distributed across scenarios. The distance to a lead vehicle is, for instance, a common parameter of interest. Each lead event that is detected as part of our query will provide a single data point for this parameter, and taking all such data points into account, it is possible to model its distribution.

Diagram 1800 includes a roadway 1802 inhabited by an ego vehicle 1804 and a lead vehicle 1806 (e.g., a singular embodiment of multiple lead vehicles over many events). A y-axis 1808 indicates a horizontal location of vehicles 1804 and 1806 across the width of roadway 1802, where the right edge of the far right lane is defined as y=0 (therefore, ego vehicle 1804 is located at y=−8). An x-axis 1810 indicates a vertical location of vehicles 1804 and 1806 along the length of roadway 1802, where the entrance to roadway 1802 is defined as x=0 (therefore, ego vehicle 1804 is located at x=4).

Diagram 1800 illustrates how various instances of vehicles observed in front of ego vehicle 1804 can be used to obtain samples of the longitudinal distance from the ego vehicle (x), and then modeled as a Gaussian or Normal distribution 1812. Diagram 1800 also shows how the lateral distance (y) may be characterized by a multi-modal or discrete distribution 1814, representing the fact that vehicles often drive within distinct lanes.

FIG. 18B is a data plot 1814 showing a parameter distribution corresponding to an example set of drive data. Data plot 1814 includes a graph of the ego vehicle's velocity (plotted on a y-axis 1816 in meters per second) versus time (plotted on an x-axis 1818 in seconds). The spikes represent times during which the vehicle was travelling at relatively high velocities, while the valleys represent times during which the vehicle was travelling at relatively low velocities (including being stopped). Data plot 1814 is derived by extracting a velocity parameter from each node of a drive graph corresponding to the drive data.

Data plot 1800 also shows which map areas 1820 the ego vehicle is in at a given time. For example, the vehicle is shown to be at a junction for a period of time prior to the 100.0 time mark. Given that the vehicle's velocity was also zero during this time, it is a strong indicator that the vehicle was stopped at a stop light. Other similar conclusions can be derived from data plot 1800. Additionally, data plot 1800 can be utilized to generate a heat map (or a subset of data of a heat map), such as that shown in FIG. 17. For example, the above scenario would be tallied as a static vehicle at a junction. As an alternative, the total time that the vehicle was static at the junction could be tallied to provide an idea of how much time is spent by the vehicle in a given scenario at a given map area.

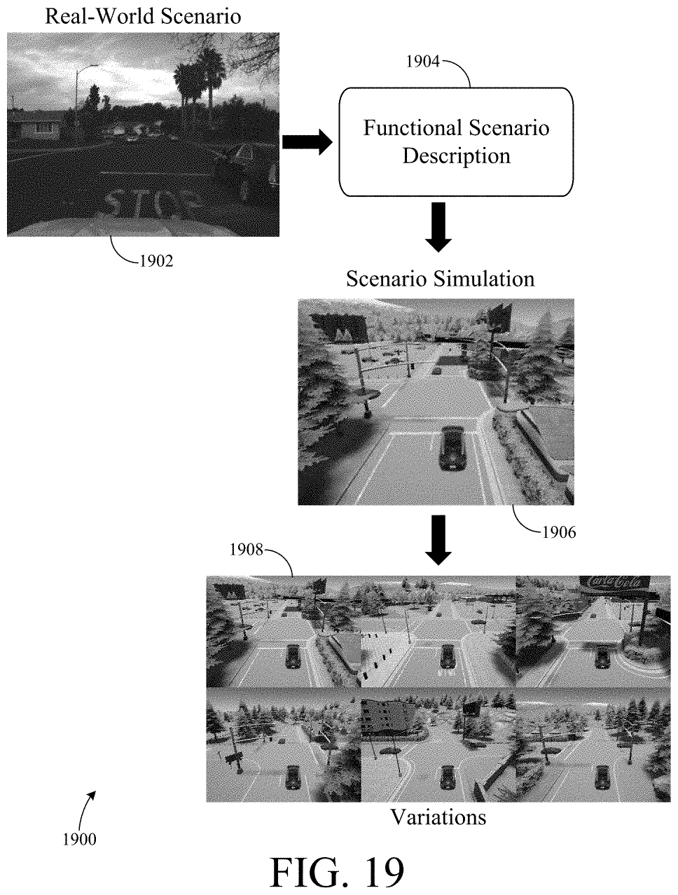

FIG. 19 is a flow chart illustrating an example method 1900 for recreating a real-world traffic scenario in a simulation. First, a real-world scenario 1902 is identified from a driving log (i.e., from an extracted scenario). Then the scenario is represented in a functional scenario description 1904. In the example embodiment, functional scenario description 1904 is a segment of software code that describes what occurred in the real-world scenario, including the surroundings, environment, etc. Example pseudocode for functional scenario description 1904 is shown below:

```
scenario:
    map: <town.xodr>
    environment:
      time: morning|afternoon|night
      weather: sun|cloud|fog|rain
actors:
- name: ego
  type: vehicle
  start: <x, y, heading>|<road, s, 1>
  destination: <x, y>
- name: adversary
  type: vehicle
  start: <ego_road, s_offset, 1_offset>
  behavior:
  - lane_follow:
    speed: Gaussian(20, 5) # m/s
  - cut_in:
    aggressiveness: [0.0 − 1.0]
```

Next, the scenario is recreated in a simulation 1906 using, for example, the segment of software code generated in the previous step. Simulation 1906 allows developers to test autonomous vehicle driving software in a realistic, simulated traffic scenario. The developers are able to evaluate, and/or alter the autonomous vehicle driving software based on feedback received from running the simulated traffic scenario. As an example, an initial version of software could cause an autonomous vehicle to swerve in response to another vehicle entering its lane, but feedback from simulation 1906 may identify this as an undesirable response. To improve the software developers may choose to alter the response of autonomous vehicle, for example, to apply a hard brake instead.

Finally, variations 1908 of the same real-world scenario are generated to create more training and testing data for developers of autonomous vehicles. Variations 1908 allow the developers to test software in particular, tailored situations based on real world scenario 1902, without needing to write an entire scenario simulation from scratch. In this final step, developers can, for example, combine two scenarios, add artificial actors, change parameter values (e.g., speeds), and/or port the scenario to a new map area, among other things. As an example, a scenario including a vehicle approaching a stop sign may be altered to include different weather, an object casting a shadow, more aggressive adversary vehicles, etc. One of ordinary skill in the art will understand that the possible variations are limited only by the capabilities of the particular simulation software utilized.

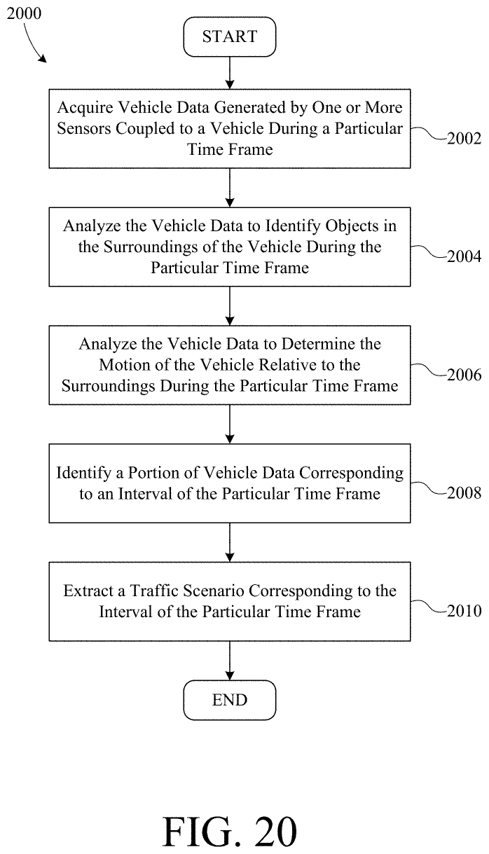

FIG. 20 is flow chart summarizing an example method 2000 for extracting traffic scenarios from vehicle data. In a first step 2002, vehicle data generated by one or more sensors coupled to a vehicle during a particular time frame is acquired. The vehicle data is at least partially indicative of the surroundings of the vehicle during the particular time frame. Then, in a second step 2004, the vehicle data is analyzed to identify objects in the surroundings of the vehicle during the particular time frame. Next, in a third step 2006, the vehicle data is analyzed to determine the motion of the vehicle relative to the surroundings during the particular time frame. Then, in a fourth step 2008, a portion of the vehicle data corresponding to an interval of the particular time frame is identified. The portion of the vehicle data is identified based at least in part on a relationship between the identified objects in the surroundings of the vehicle and the motion of the vehicle relative to the surroundings during the interval. Finally, in a fifth step 2010, a traffic scenario corresponding to the interval of the particular time frame is extracted. The traffic scenario is extracted based at least in part on the objects in the surroundings and the motion of the vehicle relative to the surroundings.

In one example, the identification of a particular time frame is accomplished by searching/filtering for predefined scenarios and/or events. An event can be predefined as some relationship between an ego vehicle and its surroundings. A scenario can be predefined as any combination of one or more of the predefined events. Then, the particular time frame(s) can be identified by searching the data for data conforming to one or more events constituting a predefined scenario.

The description of particular embodiments of the present invention is now complete. Many of the described features may be substituted, altered or omitted without departing from the scope of the invention. For example, driving data may be recorded from more and/or different sources, more or fewer scenarios may be tracked, and scenarios may be organized using a different database schema, to name a few non-limiting examples. Other potential alterations will be apparent to those having ordinary skill in the art, particularly in view of the foregoing disclosure.

We claim:

1. A method for extracting traffic scenarios from vehicle sensor data, said method comprising:
acquiring vehicle data generated by one or more sensors coupled to a vehicle, said vehicle data being at least partially indicative of the surroundings of said vehicle during a particular time frame;
analyzing said vehicle data to identify objects in said surroundings of said vehicle during said particular time frame;
analyzing said vehicle data to determine the motion of said vehicle relative to said surroundings during said particular time frame;
identifying a portion of said vehicle data corresponding to an interval of said particular time frame, said portion of said vehicle data being identified based at least in part on a relationship between said identified objects in said surroundings of said vehicle and said motion of said vehicle relative to said surroundings during said interval of said particular time frame; and
extracting a traffic scenario corresponding to said interval of said particular time frame based at least in part on said objects in said surroundings and said motion of said vehicle relative to said surroundings.

2. The method of claim 1, further comprising classifying said traffic scenario based at least in part on said objects in said surroundings and said motion of said vehicle relative to said surroundings.

3. The method of claim 2, wherein:
said identified objects include at least a second vehicle; and
said step of classifying said traffic scenario includes classifying said traffic scenario based at least in part on the relative motions between said vehicle and said second vehicle.

4. The method of claim 2, wherein:
said identified objects include at least a section of roadway infrastructure; and
said step of classifying said traffic scenario includes classifying said traffic scenario based at least in part on the motion of said vehicle relative to said section of roadway infrastructure.

5. The method of claim 4, wherein:
said one or more sensors include a global positioning system (GPS) receiver;
said vehicle data includes GPS data; and
said section of roadway infrastructure is identified based at least in part on said GPS data.

6. The method of claim 5, wherein said section of roadway infrastructure is identified based at least in part on map data.

7. The method of claim 2, wherein said step of classifying said traffic scenario includes storing an entry, indicative of said portion of said vehicle data, in a searchable database.

8. The method of claim 7, wherein said step of storing an entry indicative of said portion of said vehicle data in a searchable database includes associating said portion of said vehicle data with one or more metadata tags, said metadata tags being descriptive of said classified scenario and searchable.

9. The method of claim 1, wherein:
said one or more sensors include a camera;
said vehicle data includes video data;
said step of analyzing said vehicle data to identify objects in said surroundings of said vehicle during said particular time frame includes analyzing said video data; and
said step of analyzing said vehicle data to determine the motion of said vehicle relative to said surroundings during said particular time frame includes analyzing said video data.

10. The method of claim 9, wherein:
said one or more sensors include only a camera; and
said vehicle data includes only video data.

11. The method of claim 1, further comprising:
comparing said extracted traffic scenario to a baseline traffic scenario according to an actuarial model to generate a scenario comparison; and
utilizing said scenario comparison to inform an insurance risk calculation corresponding to said vehicle.

12. The method of claim 1, further comprising:
storing said vehicle data corresponding to said particular time frame in a first storage device;
storing said portion of said vehicle data corresponding to said interval of said particular time frame in a second storage device; and wherein
said first storage device and said second storage device have different storage attributes.

13. The method of claim 12, wherein said second storage device is more accessible than said first storage device.

14. A system for extracting traffic scenarios from vehicle sensor data, comprising:
at least one hardware processor electronically coupled to execute code, said code including a set of native instructions configured to cause a corresponding set of operations upon execution by said at least one hardware processor;
a network adapter configured to establish a connection with a data network; and
memory for storing data and said code, said code including
a data interface including a first subset of said set of native instructions configured to acquire vehicle data generated by one or more sensors coupled to a vehicle, said vehicle data being at least partially indicative of the surroundings of said vehicle during a particular time frame, and
a scenario extraction service including
a second subset of said set of native instructions configured to analyze said vehicle data to identify objects in said surroundings of said vehicle during a particular time frame,
a third subset of said set of native instructions configured to analyze said vehicle data to determine the motion of said vehicle relative to said surroundings during said particular time frame,
a fourth subset of said set of native instructions configured to identify a portion of said vehicle data corresponding to an interval of said particular time frame, said portion of said vehicle data being identified based at least in part on a relationship between said identified objects in said surroundings of said vehicle and said motion of said vehicle relative to said surroundings during said interval of said particular time frame, and
a fifth subset of said set of native instructions configured to extract a traffic scenario corresponding to said interval of said particular time frame based at least in part on said objects in said surroundings and said motion of said vehicle relative to said surroundings.

15. The system of claim 14, wherein said scenario extraction service includes a sixth subset of said set of native instructions configured to classify said traffic scenario based at least in part on said objects in said surroundings and said motion of said vehicle relative to said surroundings.

16. The system of claim 15, wherein:
said identified objects include at least a second vehicle; and
said sixth subset of said set of native instructions is configured to classify said traffic scenario based at least in part on the relative motions between said vehicle and said second vehicle.

17. The system of claim 15, wherein:
said identified objects include at least a section of roadway infrastructure; and
said sixth subset of said set of native instructions is configured to classify said traffic scenario based at least in part on the motion of said vehicle.

18. The system of claim 17, wherein:
said at least one sensor includes a global positioning system (GPS) receiver;
said vehicle data includes GPS data; and
said second subset of said set of native instructions is configured to identify said section of roadway infrastructure based at least in part on said GPS data.

19. The system of claim 18, wherein said second subset of said set of native instructions is configured to identify said section of roadway infrastructure based at least in part on map data.

20. The system of claim 15, wherein said sixth subset of said set of native instructions is configured to store an entry, indicative of said portion of said vehicle data, in a searchable database.

21. The system of claim 20, wherein said sixth subset of said set of native instructions is additionally configured to associate said portion of said vehicle data with one or more metadata tags, said metadata tags being descriptive of said classified scenario and searchable.

22. The system of claim 14, wherein:
said one or more sensors include a camera;
said vehicle data includes video data;
said second subset of said set of native instructions is configured to analyze said video data to identify said objects in said surroundings of said vehicle during said particular time frame; and
said third subset of said set of native instructions is configured to analyze said video data to determine said motion of said vehicle relative to said surroundings during said particular time frame.

23. The system of claim 22, wherein:
said one or more sensors include only a camera; and
said vehicle data includes only video data.

24. The system of claim 14, further comprising an actuarial modeling service including:
a sixth subset of said set of native instructions configured to compare said extracted traffic scenario to a baseline traffic scenario according to an actuarial model to generate a scenario comparison; and
a seventh subset of said set of native instructions configured to utilize said scenario comparison to inform an insurance risk calculation corresponding to said vehicle.

25. The system of claim 14, further comprising a storage interface including a sixth subset of said set of native instructions configured to:
store said vehicle data corresponding to said particular time frame in a first storage device; and
store said portion of said vehicle data corresponding to said interval of said particular time frame in a second storage device; and wherein
said first storage device and said second storage device have different storage attributes.

26. The system of claim 25, wherein said second storage device is more accessible than said first storage device.

27. A method for extracting traffic scenarios from vehicle sensor data, said method comprising:
acquiring vehicle data generated by one or more sensors coupled to a vehicle, said vehicle data being at least partially indicative of the surroundings of said vehicle during a particular time frame;
analyzing said vehicle data to identify objects in said surroundings of said vehicle during said particular time frame;
analyzing said vehicle data to determine the motion of said vehicle relative to said surroundings during said particular time frame;
defining a plurality of events, each event indicative of a relationship between said vehicle and said objects;
defining a scenario as a particular combination of said events;
identifying a portion of said vehicle data wherein said combination of said elements occurs during an interval of said particular time frame, said interval of said particular time frame having a predefined maximum duration; and
extracting at least some of said data of said corresponding to said interval of said particular time frame to a predefined data structure corresponding to said scenario to create an extracted scenario.

28. The method of claim 27, wherein said extracted scenario can be used in a simulator.

29. The method of claim 28, further comprising using said extracted scenario in a simulator.

30. The method of claim 27, wherein at least one of said events is defined as a particular relative movement between said vehicle and a second vehicle.

31. The method of claim 27, wherein at least one of said events is defined as the presence of a particular object in the vicinity of said vehicle.

32. The method of claim 27, wherein at least one of said events is defined as a location of said vehicle within a particular section of roadway infrastructure.

33. The method of claim 27, wherein said particular combination of events includes:
a first event defined as a particular relative movement between said vehicle and a second vehicle; and
a second event defined as the presence of a particular object in the vicinity of said vehicle.

34. The method of claim 33, wherein said particular combination of events additionally includes a third event defined as a location of said vehicle within a particular section of roadway infrastructure.
